(19) United States
(12) Patent Application Publication
(10) Pub. No.: US 2026/0017633 A1
(43) Pub. Date: Jan. 15, 2026

(54) PRODUCT DISPENSER INTERFACES

(71) Applicant: Wayne Fueling Systems LLC, Austin, TX (US)

(72) Inventors: Harish Veeravalli, Round Rock, TX (US); Murat Goksenin Guzel, Cedar Park, TX (US)

(21) Appl. No.: 19/264,448

(22) Filed: Jul. 9, 2025

Related U.S. Application Data
(60) Provisional application No. 63/669,167, filed on Jul. 9, 2024.

(51) Int. Cl. G06Q 20/20; G06F 8/65; G06Q 20/02; G06Q 20/34

(52) U.S. Cl. CPC G06Q 20/204; G06F 8/65; G06Q 20/02; G06Q 20/202; G06Q 20/341

(57) ABSTRACT

A dispenser is provided and in one embodiment can include a point-of-sale (POS) application and a pump controller operably coupled to the POS application via a first communication interface configured to exchange pump service data with the POS application via a first virtualized TCP server communicably coupling the pump controller to the POS application. The dispenser can also include a payment mechanism including a payment data processor operably coupled to the POS application via at least one second communication interface configured to exchange system service data with the POS application via a second virtualized TCP server communicably coupling the payment data processor and the POS application. The pump service data and the system service data can be generated by the POS application responsive to one or more operations performed at the dispenser. Related methods, systems, and computer-readable mediums are also provided.

### CROSS-REFERENCE TO RELATED APPLICATIONS

This application claims the benefit of U.S. Provisional application Ser. No. 63/669,167, filed on Jul. 9, 2024, and entitled “Product Dispenser Interfaces”, the entirety of which is incorporated by reference herein.

### FIELD

The current subject matter relates to providing configurable communication interfaces to a product dispenser configured in a dispensing environment. The communication interfaces can enable third-party entities, such as a retail operator of the dispensing environment, to configure and control dispenser operation, data exchange, and content provision based on their preferred guidelines or standards. In this way, customized operation of product dispensers can be enabled without requiring retrofitting or updating of software or hardware by the manufacturer of the dispenser and without limiting the third-party entity to operations, data exchange, and content provision that is initially configured by the dispenser manufacturer. As a result, third-party entities can operate a dispensing environment with improved flexibility to enhance the operational functionality of dispensers configured in their dispensing environment to best meet their customer needs and/or their preferred operating requirements for dispenser control, payment processing, and content provision or other operational workflows involving the product dispensers.

### BACKGROUND

Dispensing environments can include communication and data processing architectures that are initially implemented by manufacturers of the product dispensers configured within the dispensing environment. As a result, third-party entities, such as an individual operator, a franchisee, or a retail operator of the dispensing environment, can be limited in their ability to provide customized functionality to their customers or to operate the dispensing environment using functionality that is specifically configured for the third-party entity. Often times, third-party operators of dispensing environments seek to provide static and executable content that is specifically branded for the third-party operator. Similarly, third-party operators may wish to control aspects of the dispenser operations, payment processing, and other related dispenser or system operations of the dispensing environment in a customized manner that is specifically tailored to their operational needs and workflows.

### SUMMARY

In one aspect, a dispenser is provided and in an embodiment, the dispenser can include a point-of-sale (POS) application and a pump controller operably coupled to the POS application via a first communication interface configured to exchange pump service data with the POS application. The first communication interface can be configured to exchange the pump service data via a first virtualized TCP server communicably coupling the pump controller to the POS application. The dispenser can also include a payment mechanism including a payment data processor operably coupled to the POS application via at least one second communication interface configured to exchange system service data with the POS application. The at least one second communication interface can be configured to exchange the system service data via a second virtualized TCP server communicably coupling the payment data processor and the POS application. The pump service data and the system service data can be generated by the POS application responsive to one or more operations performed at the dispenser.

One or more additional embodiments can include one or more of the following features alone or in combination. For example, in one embodiment, the at least one second communication interface can be configured to exchange the system service data in an EMV data format. In another embodiment, a portion of the at least one second communication interface can be configured to exchange the system service data in an encrypted data format. In one embodiment, a portion of the first communication interface can be configured to exchange the pump service data in a CAN bus data format. In one embodiment, the first and second virtualized TCP servers can be configured to exchange the pump and system service data via TCP data packets including JSON formatted messages. In another embodiment, the POS application can be installed on the dispenser and configured for use by a third-party different than a manufacturer of the dispenser. The POS application can enable pump and system service data exchange for the one or more operations performed at the dispenser that are customized for the third party.

In one embodiment, the pump service data can include data characterizing at least one of configuration data of the pump controller, a software or a firmware update of the pump controller, telemetry data associated with the pump controller, diagnostic data associated with the pump controller, and log file data associated with the pump controller. In another embodiment, the pump service data can be generated responsive to the one or more operations performed at the dispenser including at least one of authorizing, deauthorizing, starting, stopping, suspending, and resuming the dispenser. In one embodiment, the pump service data can be generated responsive to one or more pump service events associated with the one or more operations of the dispenser. The one or more pump service events can include at least one of a state change of the pump controller, a status change of the pump controller, a current total volume of a dispensed product generated by the pump controller, a current total sale of a dispensed product generated by the pump controller, a final total volume of a dispensed product generated by the pump controller, a final total sale of a dispensed product generated by the pump controller, an alert generated by the pump controller, an error generated by the pump controller, or a data metric generated by the pump controller.

In another embodiment, the system service data can include data characterizing at least one of configuration data of the payment mechanism, a software or a firmware update of the payment mechanism, serial number data of the payment mechanism, status data of the payment mechanism, log data of the payment mechanism, device pairing data associated with the payment mechanism, and remote key injection data associated with the payment mechanism. In one embodiment, the system service data can be generated responsive to one or more operations performed at the dispenser including at least one of pairing a card reader of the payment mechanism with POS application, pairing a printer of the payment mechanism with the POS application, updating a driver of the payment mechanism, updating a firmware of the payment mechanism, and synchronizing clock data of the payment mechanism. In another embodiment, the system service data can be generated responsive to one mor more system service events associated with the one or more operations of the dispenser. The one or more system service events can include at least one of an online event, an offline event, a status change event, a battery status change event, a network status change event, a reboot event, a software update completion event, and a log completion event generated by the payment mechanism. In one embodiment, the dispenser can be at least one of a petroleum fuel dispenser, an electric vehicle charger, an LNG dispenser, a CNG dispenser, and a DEF dispenser.

In another aspect, a method is provided and in one embodiment, the method can include receiving, by a POS application of a dispenser, first data characterizing an installation package of a payment mechanism of the dispenser. The payment mechanism can include a memory and a payment data processor. The installation package can include a signature file associating the installation package with a third-party corresponding to the POS application. The method can also include verifying the installation package based on the signature file. The method can also include generating, by the POS application, an update software request and transmitting the update software request to a first virtualized TCP server communicably coupling the payment data processor of the payment mechanism to the POS application. The method can further include generating, by the first virtualized TCP server, a software state request and transmitting the software state request to the payment data processor. The method can also include comparing, by the first virtualized TCP server, hashed data associated with application file data stored in the memory of the payment data processor to hashed data associated with files of the installation package. The method can further include transmitting, by the first virtualized TCP server, the installation package to the payment data processor for installation. The method can also include initiating, by the payment data processor, a system service communication interface between the POS application and the payment data processor. The system service communication interface can be configured to exchange system service data therebetween via the first virtualized TCP server responsive to one or more operations performed at the dispenser.

One or more additional embodiments can include one or more of the following features alone or in combination. For example, in one embodiment, the method can further include generating, by the first virtualized TCP server, a system information request and transmitting the request to the payment data processor. Responsive to receiving a system information response, the method can also include generating, by the first virtualized TCP server, an application update status event. The method can further include providing the update status event to the POS application. The update status event can indicate an outcome of installing the installation package in the memory of the payment mechanism. In another embodiment, the system service data can include data characterizing at least one of configuration data of the payment mechanism, a software or a firmware update of the payment mechanism, serial number data of the payment mechanism, status data of the payment mechanism, log data of the payment mechanism, device pairing data associated with the payment mechanism, and remote key injection data associated with the payment mechanism. In one embodiment, the update software request can define a logical distribution path identifying a file location or directory path associated with a location of the installation package. In another embodiment, the first data can be received via a memory device storing the installation package. The memory device communicably coupled to the POS application.

In another embodiment, the first data can be received via a cloud computing device associated with the third-party. In one embodiment, responsive to receiving the installation package at the payment data processor, the first virtualized TCP server can be further configured to reset the payment mechanism and the payment mechanism is configured to reboot to install the installation package.

### BRIEF DESCRIPTION OF DRAWINGS

The details of one or more variations of the subject matter described herein are set forth in the accompanying drawings and the description below. Other features and advantages of the subject matter described herein will be apparent from the description and drawings, and from the claims. The embodiments described above will be more fully understood from the following detailed description taken in conjunction with the accompanying drawings. The drawings are not intended to be drawn to scale. For purposes of clarity, not every component may be labeled in every drawing. In the drawings:

FIG. 1 is a diagram illustrating an example embodiment of a system for controlling operations of a product dispenser via system and pump service communication interfaces described herein;

FIG. 2 is an image illustrating an example embodiment of a user-interface of a product dispenser including a point-of-sale (POS) component configurable via the system and pump service communication interfaces described herein;

FIG. 3 is a diagram illustrating an example embodiment of an architecture of a product dispenser including the system and pump service communication interfaces described herein;

FIG. 4 is a dataflow diagram illustrating data exchanged between a POS component, a pump service server, and a pump controller component via a pump service communication interface described herein during pump service start up;

FIG. 5 is a dataflow diagram continued from FIG. 4 and illustrating additional data exchanged between the POS component, the pump service server, and a pump controller via the pump service communication interface described herein during pump service start up;

FIG. 6 a dataflow diagram illustrating data exchanged between the POS component, the pump service server, the pump controller, and a user via the pump service communication interface described herein during a dispensing operation performed at a product dispenser by the user;

FIG. 7 is a dataflow diagram continuing from FIG. 6 and illustrating additional data exchanged between the POS component, the pump service server, the pump controller, and the user via the pump service communication interface described herein during a dispensing operation performed at a product dispenser by the user

FIG. 8 is a dataflow diagram continuing from of FIG. 7 and illustrating additional data exchanged between the POS component, the pump service server, the pump controller, and the user via the pump service communication interface described herein during a dispensing operation performed at a product dispenser by the user;

FIG. 9 is a dataflow diagram illustrating data exchanged between a POS component, a system service server, and a payment mechanism via the system service communication interface described herein;

FIG. 10 is a dataflow diagram continued from FIG. 9 and illustrating additional data exchanged between the POS component, the system service server, and the payment mechanism via the system service communication interface described herein;

FIG. 11 is a dataflow diagram illustrating data exchanged during a payment mechanism update sequence performed between a user, a POS component, a system service communication interface, and a payment mechanism of a product dispenser as described herein.

FIG. 12 is a dataflow diagram illustrating data exchanged during a local installation sequence performed between a user and the POS component when configuring the system and pump service communication interfaces described herein;

FIG. 13 is a dataflow diagram illustrating data exchanged during a remote installation sequence performed between a POS component and a cloud computing device associated with a third-party when configuring the system and pump service communication interfaces described herein;

FIG. 14 is an exemplary embodiment of a system block diagram of a product dispenser configured for use in the system of FIG. 1;

FIG. 15 is a diagram illustrating a perspective view of an exemplary embodiment of a product dispenser of the system of FIG. 1 configured to dispense a liquid product;

FIG. 16 is a side perspective view of an exemplary embodiment of a product dispenser of the system of FIG. 1 configured to dispense electricity;

FIG. 17 is a front perspective view of an exemplary embodiment of a product dispenser of the system of FIG. 1 configured to dispense a gaseous product; and

FIG. 18 is a block diagram of an exemplary computing system configured for use in the system of FIG. 1.

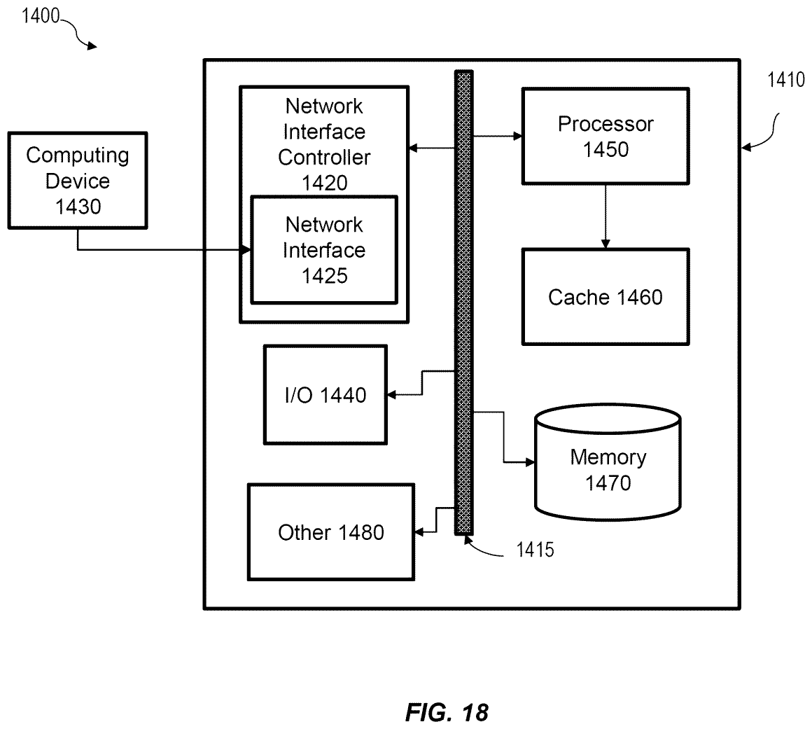

### DETAILED DESCRIPTION

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

Further, in the present disclosure, like-named components of the embodiments generally have similar features, and thus within a particular embodiment each feature of each like-named component is not necessarily fully elaborated upon. Additionally, to the extent that linear or circular dimensions are used in the description of the disclosed systems, devices, and methods, such dimensions are not intended to limit the types of shapes that can be used in conjunction with such systems, devices, and methods. A person skilled in the art will recognize that an equivalent to such linear and circular dimensions can easily be determined for any geometric shape.

Existing product dispensers are often installed in a dispensing environment with the manufacturer-provided or installed functionality and lack the ability to run third-party applications or functionality thereon. As a result, a third-party operator, such as a retail operator, a franchisee, or an individual business operator that is not the dispenser manufacturer or installer is limited in their ability to control user interface workflows, display screen sequences, graphical or textual instructions, dispenser operations, and payment transactions according to their desired practices. As a result, product dispensers can be limited to displaying content and controlling operations that were initially programmed by a dispenser manufacturer.

Often, product dispensers can be configured in retail settings or dispensing environments that can be owned and operated by a third-party that is different than the dispenser manufacturer. It can be desirable to provide interfaces for a third-party to configure the product dispenser with their own marketing/branding materials, as well as customized payment interfaces, and pump operational workflows that are associated with the third-party. In this way, customer engagement, promotional marketing, and other aspects of the customer experience at the product dispenser can be improved and pump operations can be configured as required for the third-party.

For example, the interfaces described herein can further enable more accurate tracking and reporting data associated with third-party products, services, or workflows compared to legacy product dispensers which may not be configured to enable third-party interfaces. Currently product dispenser operations and content provision is associated with a forecourt controller to control most operational aspects of a product dispenser. In such configurations, there is not a viable way for a third-party application to be hosted on a product dispenser for controlling dispenser operations and payment transactions in place of the functionality previously configured on the product dispenser by the manufacturer. Often retrofitting such configurations can require specialized hardware or personnel to replace or workaround legacy forecourt controllers, which can increase the computational complexity, costs, and maintenance of operating product dispensers in dispensing environments. The systems and methods described herein can address these shortcomings and instantiate system and pump service communication interfaces that can enable third-party functionality to be easily configured in product dispensers without needing reconfiguration or retrofitting by the manufacturer of the product dispenser.

### Dispensing Environment and System

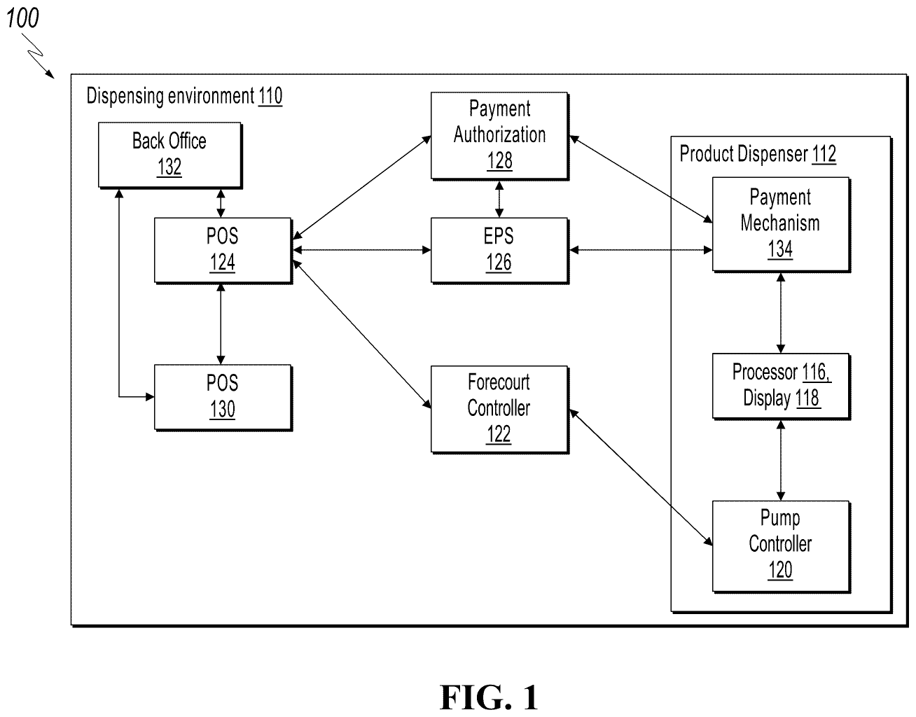

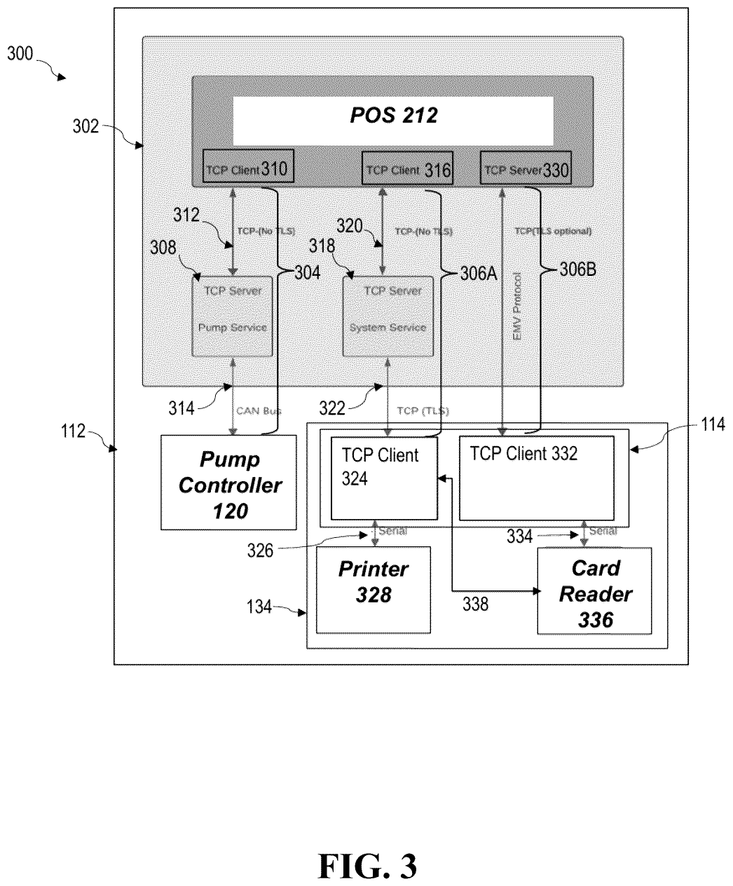

FIG. 1 is a system diagram illustrating an example system 100 that can be configured to include system and pump service communication interfaces enabling use of third-party functionality in a product dispenser as will be described herein. As shown in FIG. 1, the system 100 includes a dispensing environment 110 which can include one or more product dispensers 112 configured therein. The product dispenser 112 can be configured to dispense fuel products, such as liquid gasoline, electricity, or a gaseous fuel, such as compressed natural gas (CNG). In some embodiments, the system 100 can be configured for other types of product dispensers and is not limited to product dispensers configured to dispense fuel products. The product dispenser 112 can include a payment mechanism 134 configured to receive user payment inputs, such as personal identification and/or payment card data to pay for a dispensing transaction. The payment mechanism 134 can include a payment data processor 114, a memory storing computer-executable instructions therein, and one or more peripheral components, such as a card reader or a printer as shown in FIG. 3. The product dispenser 112 can also include a processor 116 configured to execute logic for operating the product dispenser 112. The product dispenser 112 can also include a display 118, such as an interactive touch-screen display, configured to provide static and dynamic executable content and to receive user inputs for operating the product dispenser 112 or engaging with the displayed content. The product dispenser 112 can also include a pump controller 120 configured to control dispensing operations of the product dispenser 112.

The product dispenser 112 can be operably coupled to a forecourt controller 122 configured to manage operations of one or more product dispensers 112 that can be configured in a forecourt of the dispensing environment 110. In some embodiments, the forecourt controller 122 can be configured to also manage supplies of dispensed products (e.g., inventory of dispensed products-such as fuel tanks or the like), sensors configured in the dispensing environment 110 (e.g., gas sensors, image sensors, microphones, speakers, fire suppression systems, hazard detection systems, or the like). In some embodiments, the forecourt controller 1223 can be configured within the product dispenser 112. In some embodiments, the forecourt controller 122 can be configured remote from the product dispenser and/or the dispensing environment 110. The forecourt controller 122 can be operably coupled to a POS device or component 124 configured in the dispensing environment 110. The POS component 124 can be configured to receive control signals from the forecourt controller 122 related to the dispensing operations performed at the product dispenser 112 in order to authorize the dispensing operation. The POS component 124 can also be configured to receive control signals from an electronic payment system (EPS) 126 related to payment operations associated with the dispensing operations performed at the product dispenser 112. In some embodiments, the EPS 126 can receive payment data in a first data format from the payment mechanism 134 and can convert the data to a second format that is more suitable for use by the POS 124 and/or a payment authorization entity 128 that can also be operably coupled to the EPS 126. In some embodiments, the EPS 126 can be excluded from the system 100 and the payment mechanism 134 can communicate directly with the POS 124 without the need for post-processing or formatting of data from the POS 124.

Responsive to receiving control signals from the forecourt controller 122 and/or the EPS 126 (and/or the payment mechanism 134), the POS 124 can transmit control signals and exchange data with the payment authorization entity 128 to approve or deny payment transactions for the dispensing operations performed using the product dispenser 112. The payment authorization entity 128 can return control signals and data to the POS 124 causing the forecourt controller 122 and the payment mechanism 134 to allow or deny the dispensing operations.

The system 100 can further include an additional POS 130 that can be operably coupled to the primary POS 124. The POS 130 can include, for example, a POS configured in a retail location of the dispensing environment, such as a retail location associated with a food, beverage, or service provider providing goods or services available for sale in the dispensing environment 110 via the POS 130. The POS 130 can be configured to process payment data associated with purchases of food or beverages, car washes, maintenance products or services that can be added to or processed separately from the payment data received in regard to the dispensing operations performed at the product dispenser 112. In the context of the present disclosure, the POS 124 and the POS 130 can be considered to be equivalent except where noted otherwise.

The system 100 can also include a back-office component 132 operably coupled to the POS 124 and 130. The back-office component 132 can be configured to manage functionality to be configured on the POS 124 and/or 130 that is associated with a third-party, such as a retail operator, franchisee, or individual operator of the dispensing environment 110. The back-office component 132 can store and generate data and/or control signals characterizing or associated with branding or marketing materials, static and executable content to be displayed on the display 118 of the product dispenser and/or the POS 124, 130, as well as payment processing workflows of the POS 124, 130. In some embodiments, the back-office component 132 can also be configured to manage operational workflows of the dispensing environment, such as operations of the forecourt controller 122 (and thus the product dispenser 112 via the pump controller 120) to control dispensing operations at the product dispenser 112.

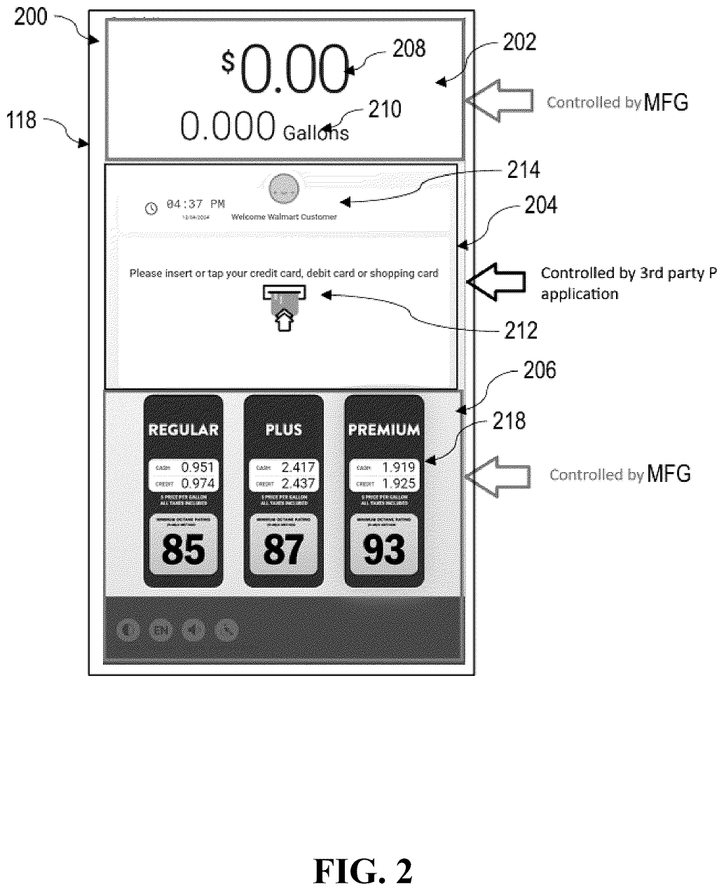

FIG. 2 is an image illustrating an example embodiment of a user-interface 200 configured for display via the display 118 of a product dispenser 112 described in relation to FIG. 1. The user-interface 200 can include a first display area 202, a second display area 204, and a third display area 206, although in some embodiments, fewer or greater numbers of display areas and variations in the arrangement of display areas can be envisioned. The display area 202 can be configured to display data characterizing the dispensing operation, such as a total sale amount 208 of the dispensed product and a volume amount 210 of the dispensed product. The contents, data, and formatting of the first display area 202 can be configured and operatively controlled by a manufacturer (MFG) of the product dispenser 112.

A second display area 204 can include including a point-of-sale (POS) component 212 configured to provide functionality associated with conducting payment transactions for the dispensing operations performed at the product dispenser 112. For example, the POS component 212 can be configured to generate and display instructions for using a payment mechanism 134 of the product dispenser 112, such as a magnetic-stripe card reader or near-field communication (NFC) card reader. In some embodiments, the POS component 212 can generate and display selectable icons representing a software-enabled pin pad to be displayed in the second display area 204, such that the user can enter identity or payment card data, such as a loyalty program ID or a PIN associated with a payment card. The POS component 212 can also be configured to generate and display additional data 214 characterizing functionality such as weather data, time of day data, location data, marketing data, advertising data, branding data, a welcome message, or the like.

The pump and system services communication interfaces described herein and enabled by the architecture provided herein allow the POS 212 to control one or more user interface flows (e.g., the arrangement of prompts, data, and instructions in various sequential, non-sequential, static, and dynamic content presentation) of the user interface 200 according to the desired formatting, branding, and user experience objectives of the third-party associated with the POS 212. For example, the POS component 212 can be configured by a third-party, such as a retail operator of the dispensing environment 110, to integrate or otherwise operate with the POS 124, 130. In this way, the third-party operator of the dispensing environment 110 can configure and operatively control instances of their desired POS (e.g., POS 124, 130, 212) as an alternative to a native POS configured by the MFG of the product dispenser 112. As the user interacts with aspects of the POS 212 provided int eh second display area 204, the POS 212 can utilize the pump and system service communication interfaces described herein to control the product dispenser for dispensing and payment operations.

The third display area 206 can be configured with one or more so fuel grade selection indications 218 that can be configured to receive a user input, such as a touch selecting a particular grade of fuel, and to cause the product dispenser 112 to dispense the selected fuel grade. The contents, data, and formatting of the third display area 206 can be configured and operatively controlled by the MFG of the product dispenser 112.

### Architecture Providing Pump and System Services Communication Interfaces

FIG. 3 is an architecture diagram illustrating an exemplary embodiment of a computing architecture 300 that can be configured in a product dispenser 112 to enable the configuration and use of pump and system service communication interfaces that can be configured to allow operational control, data exchange, and content provision between the components of the product dispenser 112 and a third-party POS component configured on the product dispenser 112, such as the POS components 124, 130, 212 described previously in regard to FIGS. 1 and 2. The aforementioned third-party POS components can be owned, operated, or otherwise configured by a third-party entity that is separate and distinct from the MFG of the product dispenser 112.

The architecture 300 can enable a pump service communication interface 304 and a system service communication interface 306 to be configured as web services between a third-party POS components 212, the pump controller 120 and the payment mechanism 134. In the embodiment shown in FIG. 3, the POS 212 can be configured on a printed circuit board (PCB) 302 that can be operatively coupled to the pump controller 120 and the payment mechanism 134. In some embodiments, the POS 212 and the pump controller 120 and one or more components of the payment mechanism 134 can be configured on the same PCB, such as the PCB 302. In some embodiments, each of the POS 212, the pump controller 120, and components of the payment mechanism 134 can be configured on the different PCBs.

The architecture 300 can include a plurality of virtualized or physical computing devices configured as servers to facilitate data exchange via the communication interfaces described herein. The server devices can be configured to exchange data using internet protocols (IP) for data exchange, such as a transmission control protocol (TCP). For example, as shown in FIG. 3, the pump service communication interface 304 can include a TCP server 308 configured on the PCB 302. The TCP server 308 can be a virtualized server configured in a memory located on the PCB 302 that can communicate with a TCP client 310 configured in the POS 212. The server 308 can be configured to exchange pump service data via interfaces 312 and 314 between the POS 212 and the pump controller 120. The pump services can include transmission of data characterizing aspects of operating the pump controller 120 to cause the product dispenser 112 to dispense a desired product therefrom. For example, the pump services data exchanged via the pump service communication interface 304 can include configuration data, operational data, and reporting data associated with operation of the pump controller 120.

The system service communication interface 306A can include a second TCP server 318 configured on the PCB 302. The TCP server 318 can be a virtualized server configured in a memory located on the PCB 302 that can exchange non-payment data, such as control signals, via communication interface 306A between a TCP client 316 configured in the POS 212 and a TCP client 324 configured in the payment mechanism 134. The TCP client 324 can be operably coupled to the payment data processor 114. The server 318 can be configured to exchange non-payment related system service data via interfaces 320 and 322 between the TCP client 316 and the TCP client 324, which can be operatively coupled to a printer 328 of the payment mechanism 134 via a serial interface 326. For example, the non-payment system service data exchanged via the system service communication interface 306A can include data characterizing firmware versions and upgrades, serial numbers, status and error log data, device pairing data and the like.

A second system service communication interface 306B can be configured to exchange payment related system service data in the Europay, Mastecard, Visa (EMV) standard data format between a TCP server 330 configured in the POS 212 and a TCP client 332 configured in the payment mechanism 134 and operably coupled to the payment data processor 114. The TCP client 332 can be operatively a card reader 336 of the payment mechanism 134 via a serial interface 334, which can couple the card reader 336 to the payment data processor 114. For example, the payment related system service data exchanged via the second system service communication interface 306B can include

As shown in FIG. 3, the servers 308, 318, and 330 can be configured as TCP servers configured to exchange TCP data packets with the components they are operably coupled to and clients 310, 316, 324, and 332 can be configured as TCP clients that can also be configured to exchange TCP data packets. In some embodiments, one or more of the interfaces 304, 306A, and 306B can be configured to enable a transport level security (TLS) protocol for exchanging TCP data packets over the communication interfaces 304 and 306. In some embodiments, one or more portions of the communication interfaces 304 and 306 may use TLS protocol, while another portion of the communication interfaces 304 and 306 may not use TLS protocol, such as the interfaces 312 and 320. In some embodiments, a portion of the communication interface 304 can be configured to exchange data via a controller area network (CAN) bus protocol, such as the interface 314 configured to exchange data between the TCP server 308 and the pump controller 120. In some embodiments, the TCP clients 324 and 332 can be configured to exchange data with coupled components via serial interfaces, such as the interfaces 326 and 334, which enable data exchange between TCP client 324 and the printer 328, as well as between the TCP client 332 and the card reader 336, that are configured within the payment mechanism 134 of the product dispenser 112.

With the foregoing description of the architecture 300 in mind, the functionality of the TCP server 308 configured to provide pump services data and the TCP server 318 configured to provide system services data can be explained in more detail.

### Pump Services

The TCP server 308 can be configured to enable pump service data exchange between the POS 212 and the pump controller 120. For example, the TCP server 308 can enable data exchange of pump service data characterizing data associated with pump controller configurations, pump controller control signaling, pump controller software and firmware updates, pump controller telemetry data, pump controller diagnostic data, and pump controller log file data via the communication interface 304.

The TCP server 308 can provide pump services via one or more pump service application programming interfaces (API) to communication with a third-party application, such as the POS 212, and with the pump controller 120. For example, the pump service APIs can be configured to request or exchange data related to authorizing, deauthorizing, starting, stopping, suspending, and resuming a pump of the product dispenser 112, via the pump controller 120. In some embodiments, the pump service APIs can be configured to request or exchange data characterizing pump status acquisition, unit price updates for dispensed products, acquiring total sale and total volume data associated with a dispensing operation, acquiring a version number of the pump controller, setting dispenser identifiers for dispensers of the product dispenser 112, or updating dispensed product selection grades, such as fuel grade selections.

The exchange of pump service data via the pump services API and the TCP server 308 can be enabled based on one or more pump service events, which can include, but are not limited to a change in pump state (e.g., conveyed via a pump state USCL message), a pump status event (e.g., an online status or an offline status), a current total volume of a dispensed product, a current total sale of a dispensed product, a final total volume of a dispensed product, a final total sale of a dispensed product, summary totalizer data that is generated after each dispensing operation for a selected dispensed product grade, as well as generated alerts, errors, or data metrics associated with operation of the pump controller 120.

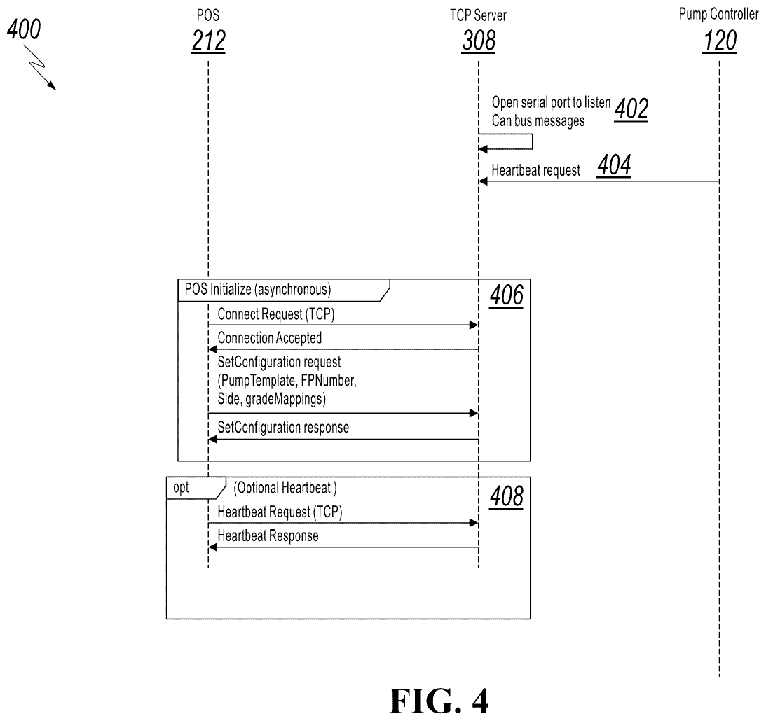

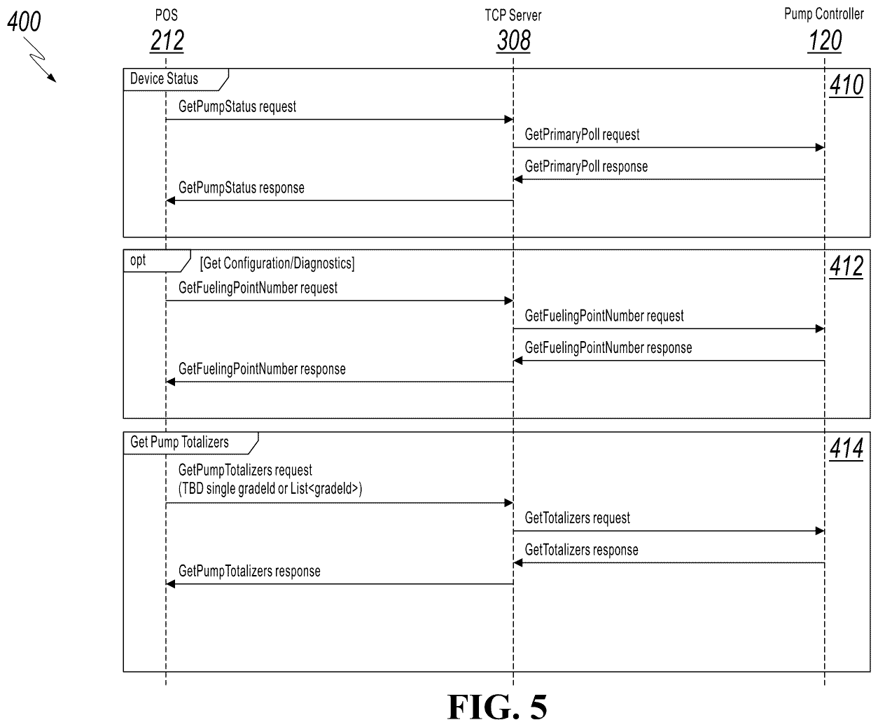

An exemplary embodiment of a dataflow 400 illustrating data exchanged between the POS 212, the TCP server 308, and the pump controller 120 via the pump service communication interface 304 described herein during pump service start up is shown in FIGS. 4-5. FIG. 5 is continued from FIG. 4. During operation, the TCP server 308 can be configured to listen for CAN bus messages received via the interface 314 on a predetermined serial port of the TCP server 308. At 402, the TCP server 308 can open a serial port to listen for the incoming CAN bus messages that can be sent by the pump controller 120. At 404, the TCP server 308 can receive a heartbeat request from the pump controller 120 that can be used to synchronize communication via the pump service communication interface 304. The pump controller 120 can generate the heartbeat request on a predetermined schedule or frequency. If the pump controller 120 fails to generate and send the heartbeat request, the TCP server 308 can determine that the pump controller 120 is offline.

At 406, the POS 212 can be initialized by sending a connection request to the TCP server 308, which in turn can reply to indicate the connection is accepted. The POS 212 can then request configuration data from the TCP server 308, such as a template of the product dispenser 112. The product dispenser template can include a configuration of the product dispenser 112, such as a number of dispenser points, dispensed product grades, locations of the dispenser points on the or in the product dispenser 112, and mapping data identifying the particular grade of dispensed product that is associated with each of the dispenser points configured in the product dispenser 112. The TCP server 308 can return the requested configuration data to the POS 212.

In some embodiments, at 408, the POS 212 can optionally generate a heartbeat request to synchronize communication via the pump service communication interface 304 with the TCP server 308. For example, the POS 212 can generate a heartbeat request on a predetermined schedule or frequency and the heartbeat request can be transmitted to the TCP server 308 via the pump services communication interface 304. The TCP server 308 can return a heartbeat response to the POS 212 confirming their synchronization. In some embodiments, if the predetermined socket on the TCP server 308 at which data is received via the pump services communication interface 304 is open and the heartbeat or any other command is not received in a predetermined amount of time the TCP server 308 can close the socket connection.

As shown in FIG. 5, the dataflow 400 can also include exchanging data related to determining a status of the product dispenser 112 and/or a dispensing point of the product dispenser 112. For example, at 410, a status of the product dispenser 112 can be ascertained. The POS 212 can generate and transmit a pump status request to the TCP server 308. The TCP server 308 can query the pump controller 120 and receive a response. The TCP server 308 can then determine and transmit a pump status response indicating a status of the pump controller 120. The status of the pump controller 120 can be indicative of a state of the product dispenser 112.

In some embodiments, a status of a particular dispensing point can be determined and shared between the TCP server 308 and the POS 212. For example, at 412, the POS 212 can request a dispensing point identifier from the TCP server 308. The TCP server 308 can transmit a request for the dispensing point identifier to the pump controller 120 and receive a response therefrom identifying one or more dispensing points of the product dispenser 112. The TCP server 112 can transmit the dispensing point identification data to the POS 212.

In another embodiment, the POS 212 can request pump totalizer data and can transmit the request to the TCP server 308. For example, at 414, the TCP server 308 can transmit a request for the same to the pump controller 120 and can receive a response from the pump controller 120 including the pump totalizer data which can be provided to the POS 212. The pump totalizer data can characterize a total sale amount or a total volume amount associated with a product dispensed from the dispensing point of the product dispenser 112.

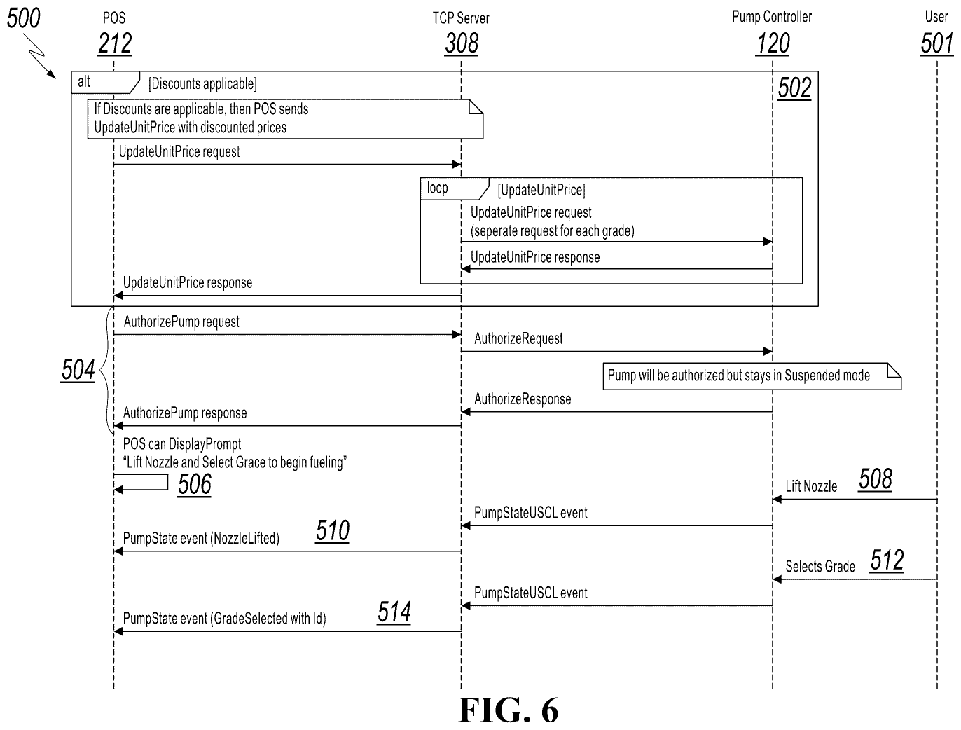

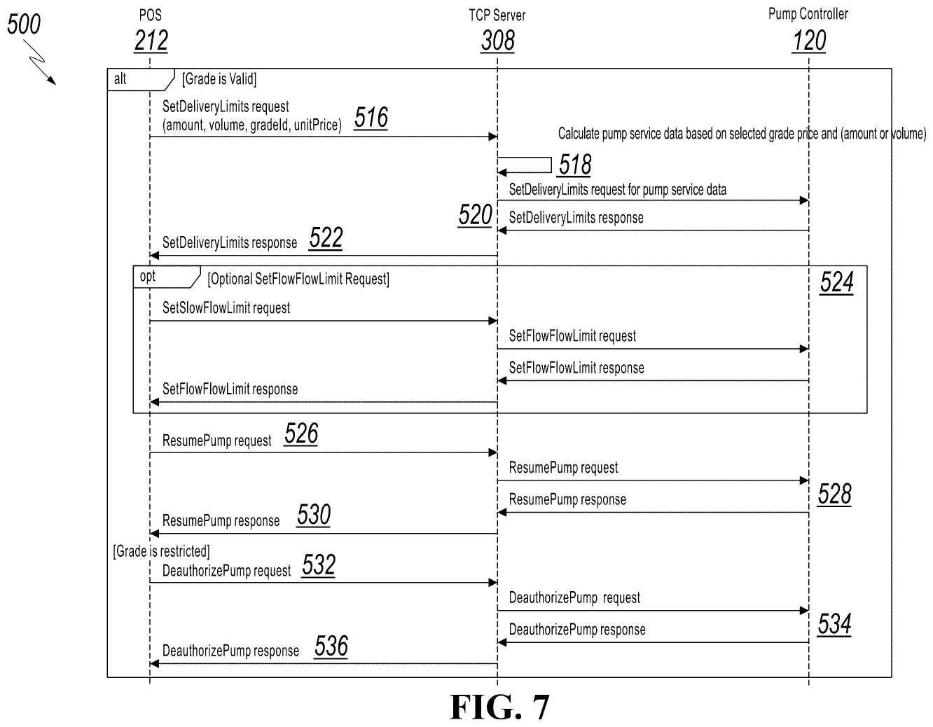

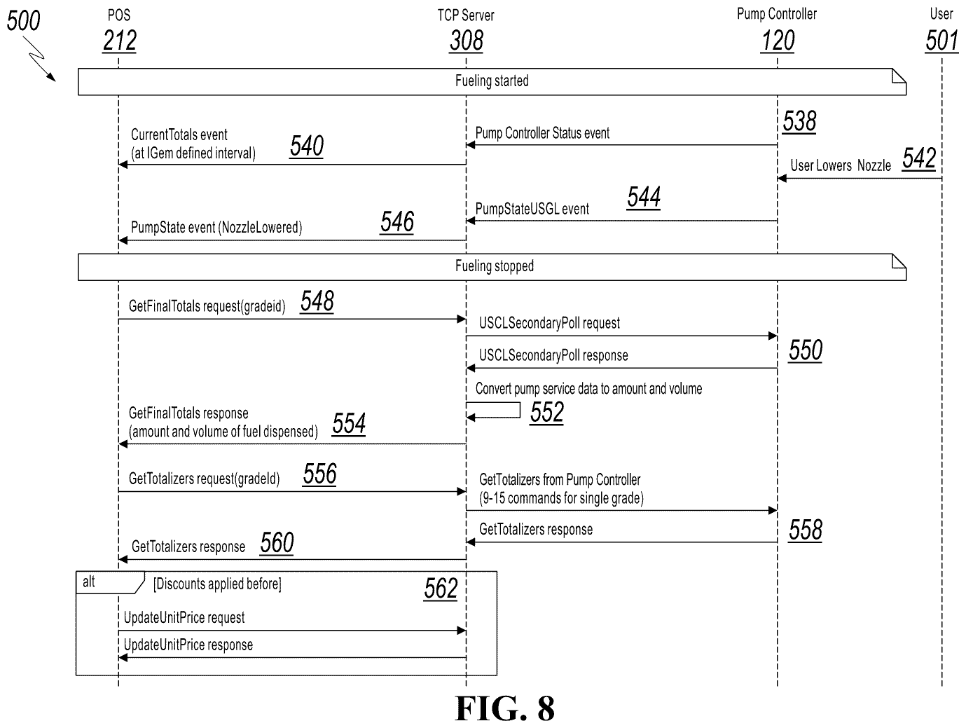

An exemplary embodiment of a dataflow 500 illustrating data exchanged between the POS 212, the TCP server 308, the pump controller 120, and a user 501, during a dispensing operation performed at a product dispenser 112 by the user is shown in FIGS. 6-8. FIG. 7 is continued from FIG. 6 and FIG. 8 is a continuation of FIG. 7. Initially, for example, as shown at 502, the system 100 can be configured to determine if any discounts are applicable for the dispensed products and the POS 212 can be updated to apply the discounts. The POS 212 can generate and transmit an update unit price request and send the request to the TCP server 308. The TCP server 308 can iteratively request updated unit price data from the pump controller 120 for each grade of dispensed product configured in the product dispenser 112. The pump controller 120 can return a response including the updated unit price data to the TCP server 308, which can be transmitted to the POS 212 to update the particular unit prices displayed and applied to payment transactions of the dispensing operations.

At 504, the POS 212 can generate and transmit a request to the TCP server 308 to authorize the pump controller 120 (and thus, the dispensing point at which the user 501 is seeking to acquire the dispensed product from the product dispenser 112, e.g., a product dispenser user). The server 308 can transmit the authorization request to the pump controller 120 and can receive a response from the pump controller 120 that can be transmitted back to the POS 212. The pump controller 120 can be authorized but can remain in a suspended or idle state until dispensing begins. At 506, the POS 212 can generate and provide a display prompt via the display 118 (e.g., on the user interface 200). The display prompt can instruct the user 501 to “Lift Nozzle and Select Grade to Begin Fueling” or the like to inform the user 501 to take action to dispense a product from the product dispenser. At 508, the user 501 can lift a nozzle associated with the dispensing point and a pump state USCL event corresponding to the actuation of the nozzle can be transmitted from the pump controller 120 to the TCP server 308 and then to the POS 212 at 510. The user 501, at 512, can then select a desired grade of a dispensed product to be dispensed via the dispensing point. The pump controller 120 can generate and transmit a pump state USCL event corresponding to selection of a product grade at a particular dispensing point to the TCP server 308, which can receive the pump state USCL event corresponding to selection of the product grade at a particular dispensing point to the POS 212 at 514.

Continuing the dataflow 500 of the dispensing operation shown in FIG. 7, at 516 the POS 212 can generate and transmit a delivery limit request to the TCP server 308. The delivery limit request can include threshold limits for an amount of the dispensed product, a volume of the dispensed product, the selected grade of the dispensed product selected at 512, and a unit price of the selected grade of the dispensed product. The TCP server 308 can iteratively at 518 determine pump service data based on the selected grade, amount, or volume of the dispensed product. At 520, the TCP server 308 can generate and transmit the delivery limit request to the pump controller 120 and can receive a response therefrom that can be transmitted by the TCP server 308 to the POS 212 where it is received at 522.

In some embodiments, the POS 212, the TCP server 308, and the pump controller 120 can be configured to set a reduced flow rate of the selected product dispensed from the dispensing point of the product dispenser 112. For example, as shown in 524, the POS 212 can generate a set slow flow limit request and transmit the request to the TCP server 308, which in turn can generate and transmit the set slow flow limit request to the pump controller 120. The pump controller can generate and transmit a response to the TCP server 308, which can be passed to the POS 212.

At 526, the POS 212 can generate and transmit a request to the TCP server 308 to resume pumping following an idle state or to commence pumping of the dispensed product. The resume pump request can be transmitted by the TCP server 308 to the pump controller, where at 528 a response to the pump resume request can be generated and returned to the TCP server 308. At 530, the resume pump response can be received by the POS 212 from the TCP server 308.

In some embodiments, a particular dispensed product grade can be restricted or otherwise made unavailable to the user 501. For example, if the selected grade of the dispensed product is unavailable or restricted, the POS 212 will not generate and transmit set delivery limit requests (at 516) or resume pump request (at 526) so that dispensing of the restricted product will be prohibited. Instead, as shown at 532, the POS 212 can generate and transmit a deauthorize pump request once the nozzle of the product dispenser 112 is lowered. The deauthorization request can be transmitted from the TCP server 308 to the pump controller 120 and at 534, the pump controller 120 can generate and transmit a deauthorize pump response that is provided to the TCP server 308 and further transmitted to and received at 536 by the POS 212.

Continuing the dataflow 500 as shown in FIG. 8, as product dispensing has begun the pump controller 120 at 538 can generate and transmit a pump start status event to the TCP server 308. At 540, the TCP server 308 can generate and transmit a current totals event that can be transmitted to the POS 212. The user 501 can lower the nozzle at 542 and the pump controller 120 at 544 can generate and transmit a pump state USCL event corresponding to the end of the product dispensing that can be transmitted to the TCP server 308, which in turn at 546 can generate and transmit a pump state event to be provided to the POS 212.

At the conclusion of dispensing the product, the POS 212 at 548 can generate and transmit a request to the TCP server 308 requesting final totals for the sale amount and the volume of the dispensed product. The TCP server 308 can generate a secondary poll request for the sale amount and the volume of the dispensed product that can be transmitted to the pump controller 120 and once received at 550, the pump controller 120 can generate and transmit a response to the secondary poll request for the sale amount and the volume of the dispensed product. At 552, the TCP server 308 can iteratively convert the pump service data to the sale amount and the volume of the dispensed product. At 554, a response including the final totals for the sale amount and the volume of the dispensed product can be received at the POS 212. The POS 212, at 556, can generate and request totalizer data characterizing totals of the pump service data transmitted during the dispensing operation. The request can be transmitted to the TCP server 308 and to the pump controller 120, where at 558, the pump controller 120 can provide a response to the request for totalizer data, which can be transmitted to the TCP server 308 and received, at 560 by the POS 212.

In some embodiments, if discounts were previously applied, the POS 212 can request the updated discount prices. For example, at 562, the POS 212 can generate and transmit an update unit price request that can be transmitted to the TCP server 308. The TCP server 308 can respond and can provide the POS 212 with the requested updated unit price data.

### System Services

Returning to FIG. 3 and turning now to the TCP server 318 configured to enable exchange of system service data between the POS 212 and the payment mechanism 134, the TCP server 318 can enable data exchange of pump service data characterizing configuration data of the devices or components of the product dispenser 112, such as firmware versions, serial numbers, part numbers, or the like of the payment mechanism 134 and components thereof, such as the printer 328 and the card reader 336. The TCP server 318 can also enable exchange of system service data for configuring upgrades for the payment mechanism 134 and components thereof, such as the printer 328 and the card reader 336. In some embodiments, the TCP server 318 can also enable exchange of system service data including status and error log data, system and application log data, device pairing data, remote key injection data, and configuration file data.

In some embodiments, the TCP server 318 can enable the exchange of system service data configured to enable pairing between the card reader 336 and other components of the product dispenser 112, such as the printer 328, display 118, or display portions 202-206 the user interface 200. For example, the TCP server 318 can enable the exchange of system service data for pairing the card reader 336 with the POS 212 via the client 324 and the interface 338. In this way, the TCP server 318 can enable exchange of system service data to allow for upgrading applications configured on the devices or components of the product dispenser 112. In some embodiments, the TCP server 318 can enable the exchange of system service data associated with the card reader 336 or the printer 328, such as data to configure a type of card reader or printer, a driver version, firmware version, or transmit a serial number of the card reader 336 or the printer 328. In some embodiments, the TCP server 318 can enable the exchange of system service data including application versions, network-related data (such as an IP address of one or more components of the product dispenser 112), clock data for timing synchronization, and financial key data.

The TCP server 318 can provide system services via one or more system service APIs to communicate with a third-party application, such as the POS 212. For example, one or more of the system service APIs can be configured to request and exchange diagnostic data or to request and exchange package detail data associated with the pump services, system services, or an EMV application. In some embodiments, one or more of the system service APIs can be configured to request and exchange system information such as operating system data, board/device data, disk data, memory data, battery data, time or clock data, network data, USB data or other data characterizing the payment mechanism 134. In some embodiments, one or more of the system service APIs can be configured to request and exchange software update data for the payment mechanism 134 or components thereof, such as configuration file data, binary data, firmware data, or a combination thereof. In some embodiments, one or more of the system service APIs can be configured to request and exchange data associated with rebooting the payment mechanism 134, acquiring log or configuration data of the payment mechanism 134, updating a configuration of the payment mechanism 134, or requesting operational and/or maintenance data of the payment mechanism 134.

The exchange of system service data via the system services API and the TCP server 318 can be enabled based on one or more system service events, which can include, but are not limited to an online, offline, or status change event of the payment mechanism 134. The system service events can also include a battery status change, or a network work status change of the payment mechanism 134 or the user interface 200. In some embodiments, the system service events can also include a reboot event, a software update completion event, or a log completion event of the payment mechanism 134.

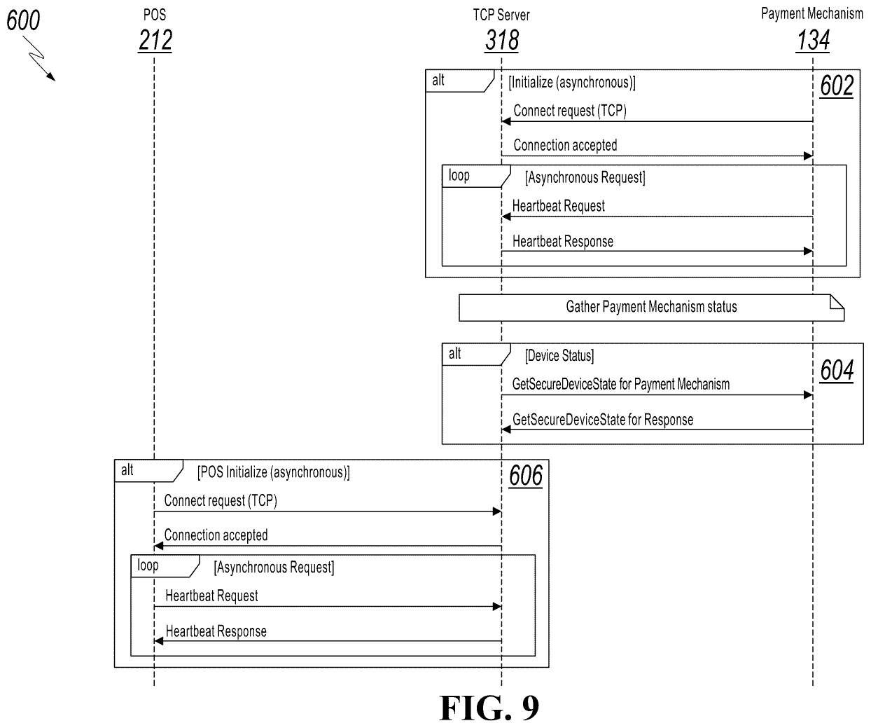

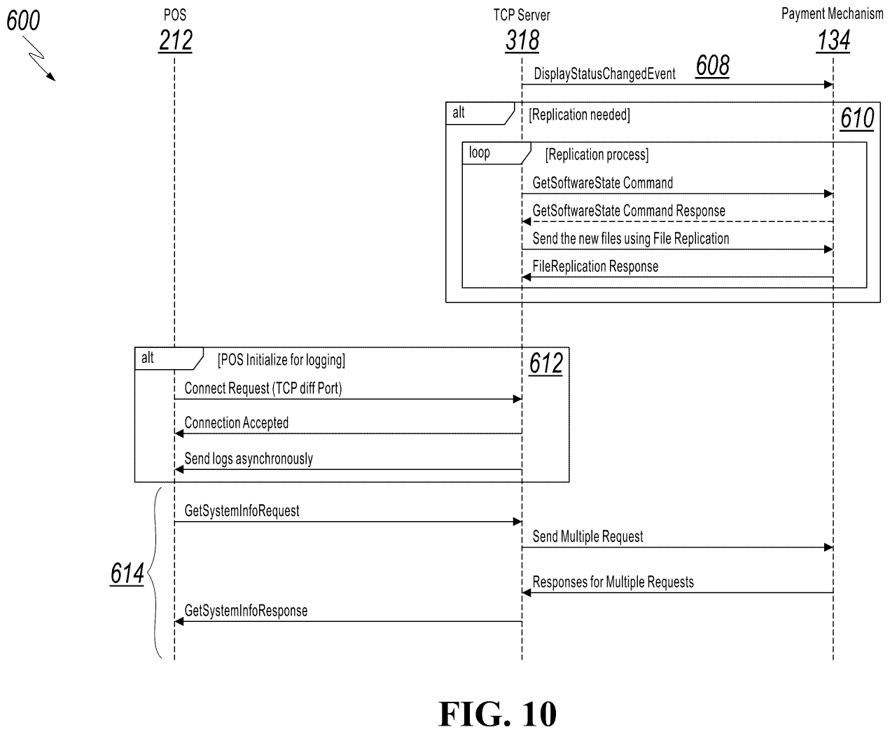

An exemplary embodiment of a data flow 600 for providing system service data via the communication interfaces 306 and the TCP server 318 is shown in FIGS. 9-10 and illustrates data exchanged between the POS 212, the TCP server 318, and the payment mechanism 134. FIG. 10 is continued from FIG. 9. As shown in FIG. 9, the dataflow 600 can include an initialization at 602 between the payment mechanism 134 and the TCP server 318. For example, with the payment mechanism 134 and the TCP server 318 having previously paired, the payment mechanism 134 can transmit a connection request to the TCP server 318, which can return a connection acceptance message to the payment mechanism 134. The payment mechanism 134 can generate a heartbeat request that is received by the TCP server 308 and in response generates a heartbeat response provided to the payment mechanism 134 to establish synchronization therebetween. In some embodiments, the payment mechanism 134 can generate the heartbeat request on a predetermined schedule or frequency, such as after every 10 second interval.

At 604, the TCP server 318 can acquire status data of the payment mechanism 134. For example, the TCP server 318 can generate and transmit a status request to the payment mechanism 134. The payment mechanism 134 can respond with the requested status data. At 606, the POS 212 can generate and transmit a connection request to the TCP server 318 and the TCP server 318 can generate and transmit a connection acceptance response back to the POS 212. To further maintain synchronization between the POS 212 and the TCP server 318, the POS 212 can generate and transmit a heartbeat request to the TCP server 318, which in turn once received can generate and transmit a heartbeat response back to the POS 212. In some embodiments, the POS 212 can generate the heartbeat request on a predetermined schedule or frequency, such as after every 10 second interval.

As shown in FIG. 10, the dataflow 600 can further include at 608 configuring an operational display status of the payment mechanism 134 responsive to establishing the system service communication interfaces 306 with the POS 212. For example, as shown at 608, the TCP server 318 can generate and transmit to the payment mechanism 134 a display status change event.

At 610, the TCP server 318 and the payment mechanism 134 can establish a replication process. The replication process can include the TCP server 318 generating and transmitting a command to get a software state from the payment mechanism 134, which can respond with a response including the software state of the payment mechanism 134. The TCP server 318 can transmit new files using file replication to the payment mechanism 134, which can return a file replication response to the TCP server 318.

At 612, the POS 212 can transmit a connection request to the TCP server 318 to connect on a different port. For example, in some embodiments, logging data can be conveyed between the POS 212 and the TCP server 318 on the different port. In these embodiments, the POS 212 can generate and transmit a connection request to the TCP server 318, which can return a connection acceptance response. The TCP server 318 can subsequently transmit log data asynchronously to the POS 212. In some embodiments, the log data can be conveyed using a publication/subscription model in place of TCP/IP data transmission.

At 614, the POS 212 can generate and transmit a request to get system information to the TCP server 318, which can send multiple requests to the payment mechanism 134 for the system information associated with the payment mechanism 134. For example, the payment mechanism 134 can provide system information such as application version data associated with the payment mechanism 134, firmware version data, operating system firmware data, firmware data associated with the card reader 336, software and firmware update status data, as well as memory and flash drive status data, such as the amounts of available free space in the memory or flash drive. The TCP server 318 can receive the system information response and provide to the POS 212.

### Payment Mechanism Updating

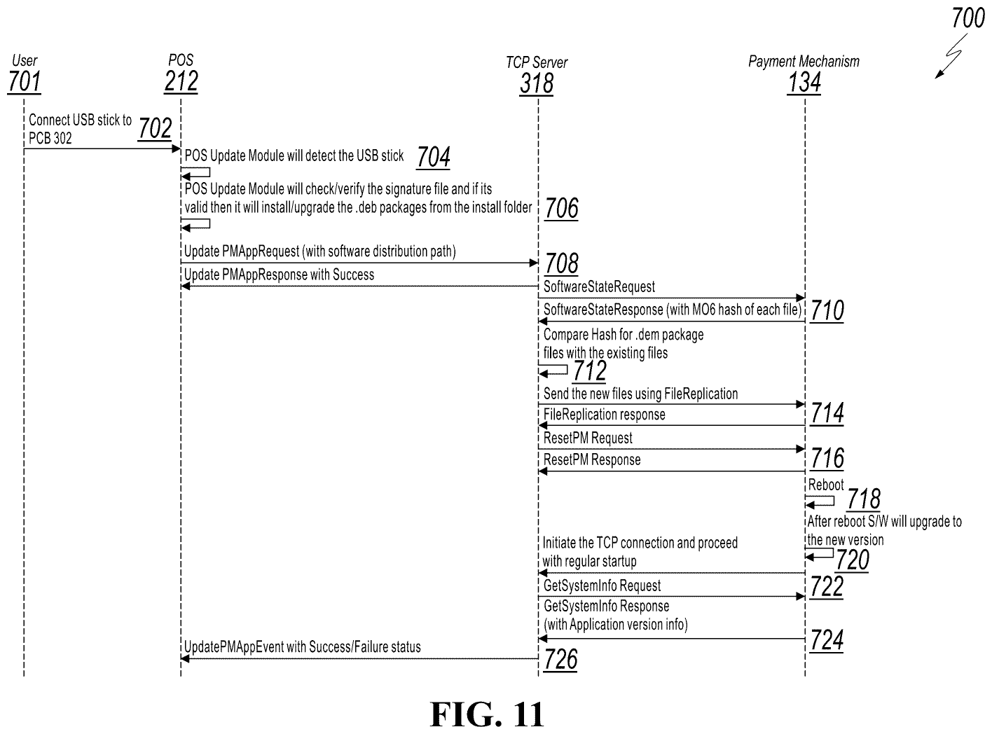

FIG. 11 is dataflow diagram illustrating an exemplary embodiment of a dataflow 700 exchanged during a payment mechanism update sequence performed between a user 701, the POS 212, the TCP server 318, and the payment mechanism 134 of the product dispenser 112 via the system service communication interfaces 306 as described herein for updating the payment mechanism 134. In the aforementioned embodiment, the user 701 can be a technician or operator of the dispensing environment 110 and/or affiliated with a third-party provider of the POS 212. The user 701 can have a non-transitory memory device, such as a universal serial bus (USB) drive, flash drive, or the like, storing an executable installation file or package of files that are configured to install an updated software version of the payment mechanism 134. The package of files can include a signature file that can be used to verify the authenticity and security of the updated software to be installed on the payment mechanism 134 and to confirm that the software corresponds to the third-party associated with the POS 212.

At 702, the user 701 can connect the memory device to the PCB 302 to be in operable communication with the POS 212. At 704, an update module configured in the POS 212 can detect the memory device and at 706, the update module can verify if the signature file is valid and from a trusted source. Once confirmed as a trusted installation package, the POS 212 can proceed to install the updated payment mechanism files in a memory of the PCB 302 that is operatively connected to the POS 212. At 708, the POS 212 can generate and transmit a payment mechanism (PM) update software request to the TCP server 318. The update software request can include a software distribution path identifying a file location or directory path identifying an install location for the updated payment mechanism software at the payment mechanism 134. The TCP server 318 can return a response indicating the update software request was successfully received. At 710, the TCP server 318 can generate and transmit a software state request that is provided to the payment mechanism 134, which can respond to the TCP server 318 with a software status response that includes a hashed or otherwise encrypted version of each file to be updated. At 712, the TCP server 318 can compare the hash values for the files in the updated software package to be installed with the hash values of the existing files received from the payment mechanism 134. Responsive to determining the hash values match, the TCP 318 can be configured to discontinue the update process.

At 714, responsive to determining that the has values do not match, the TCP server 318 can be configured to transmit the updates software package to the payment mechanism 134 for file replication at the payment mechanism 134. The payment mechanism 134 can send a response to the TCP server 318 confirming the file replication. At 716, the TCP server 318 can generate and transmit a PM reset request to reset the payment mechanism 134 and the payment mechanism 134 can provide a PM reset response. At 718, the payment mechanism can reboot and at 720, after the reboot, the updated payment mechanism software will be installed and configured on the payment mechanism 134.

At 722, the payment mechanism 134 can initiate the system service communication interface 306 with the TCP server 318 and can proceed with normal start-up operations of the payment mechanism 134 using the updated payment mechanism software. At 724, the TCP server 318 can generate and transmit a request for system information to the payment mechanism 134, which can response with a response that provides the version number data for the new, updated payment mechanism software. At 726, the TCP server 318, can generate and transmit an PM application update status event to the POS 212 with status indicating whether the application update of the payment mechanism 134 was a successful or failed.

### Local Configuration of Pump and System Service Communication Interfaces

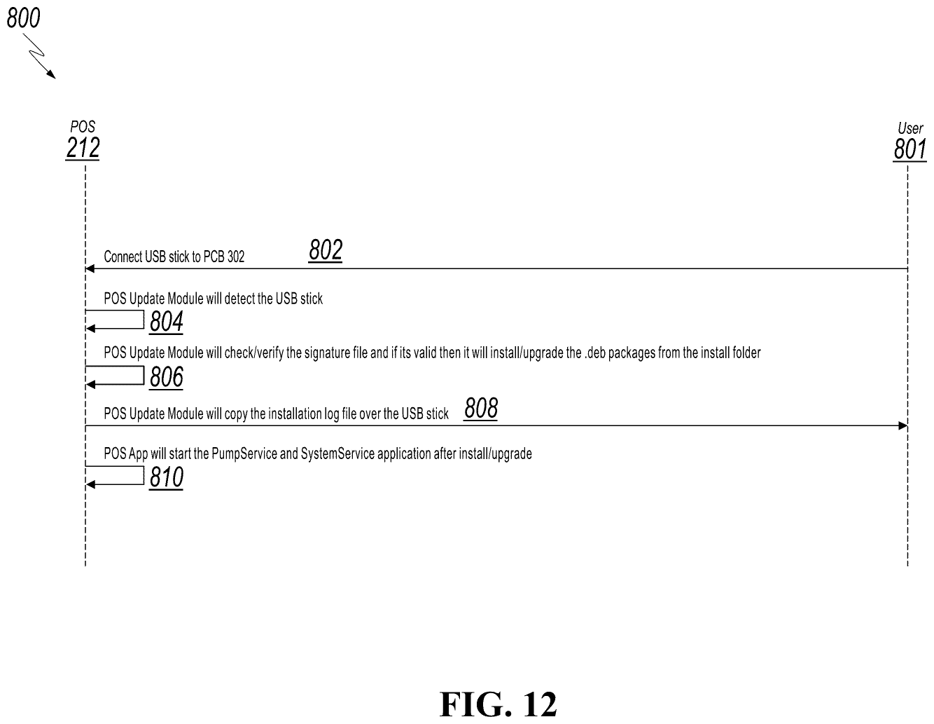

FIG. 12 is a dataflow diagram illustrating an exemplary embodiment of a dataflow 800 exchanged during a local installation sequence performed between a user 801 and the POS 212 when configuring the pump service communication interface 304 and the system service communication interfaces 306 described herein. An assumption can be that a security door of the product dispenser 112 is disabled or disarmed by an on-premise operator or personnel (or via an API). The user 801 can be a technician or operator of the dispensing environment 110 and/or affiliated with a third-party provider of the POS 212. The user 801 can have a non-transitory memory device, such as a universal serial bus (USB) drive, flash drive, or the like, storing an executable installation file or package of files that are configured to instantiate the TCP servers 308, 318, 330 and the TCP clients 310, 316, 324, 332 and configure the pump service communication interface 304 and the system service communication interface 306. The package of files can include a signature file that can be used to verify the authenticity and security of the executable installation file or package of files to be installed on the POS 212. In some embodiments, the package of files can include .deb formatted files for distribution on Linux®-based operating systems. In some embodiments, the package of files can include .msi formatted filed for distribution in Microsoft®-based operating systems.

At 802, the user 801 can connect the memory device to the PCB 302 to be in operable communication with the POS 212. At 804, an update module configured in the POS 212 can detect the memory device and at 806, the update module can verify if the signature file is valid and from a trusted source. Once confirmed as a trusted installation package, the POS 212 can proceed to install the package of files instantiating the TCP servers 308, 318, 330 and the TCP clients 310, 316, 324, 332 to configure the pump service communication interface 304 and the system service communication interface 306 in a memory of the PCB 302 that is operatively connected to the POS 212.

At 808, the update module of the POS 212 can copy the installation log file to the memory device and at 810, the POS 212 can instantiate the pump service communication interface 304 and the system service communication interfaces 306 following the successful installation.

### Remote Configuration of Pump and System Service Communication Interfaces

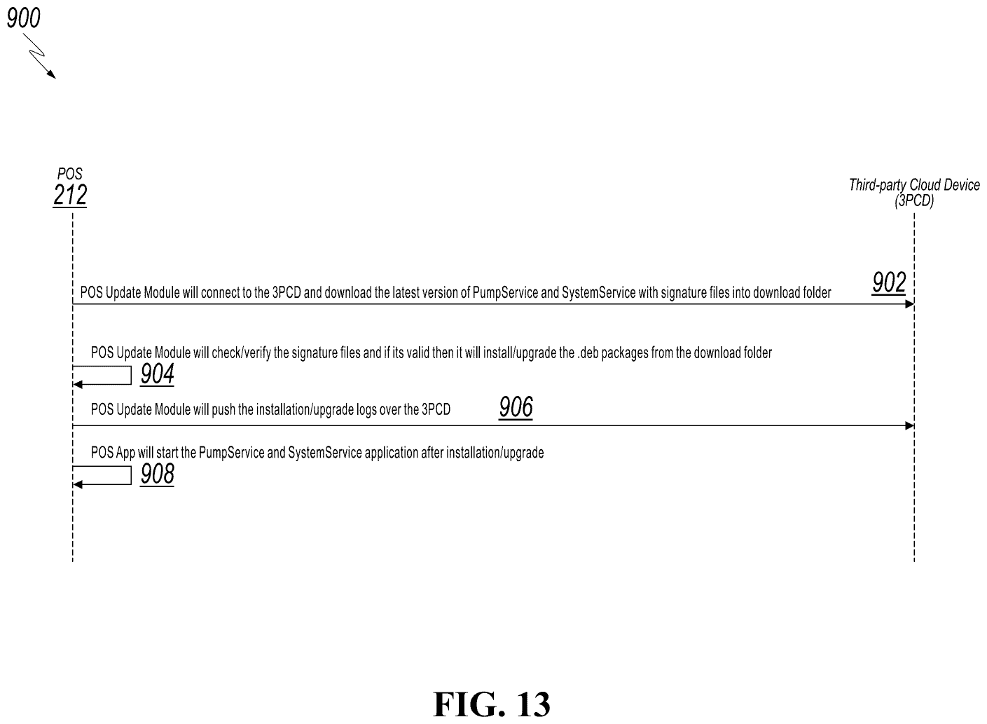

FIG. 13 is a dataflow diagram illustrating an exemplary embodiment of a dataflow 900 exchanged during a remote installation sequence performed between the POS 212 and a cloud computing device associated with a provider or intended user of the third-party POS 212 when configuring the pump service communication interface 304 and the system service communication interfaces 306 described herein. The cloud computing device (e.g., the third-party cloud device or 3PCD) can be configured to store and provide an installation package having an executable installation file or package of files that are configured to instantiate the TCP servers 308, 318, 330 and the TCP clients 310, 316, 324, 332 and configure the pump service communication interface 304 and the system service communication interface 306. The package of files can include a signature file that can be used to verify the authenticity and security of the executable installation file or package of files to be installed on the POS 212. In some embodiments, the package of files can include .deb formatted files for distribution on Linux®-based operating systems. In some embodiments, the package of files can include .msi formatted filed for distribution in Microsoft®-based operating systems. In some embodiments, the POS 212 can configure a Chromium®-based web page to access the package of files at the 3PCD through an open-source or proprietary package manager.

For example, as shown in FIG. 13, at 902, an update module of the POS 212 can connect to the 3PCD and download the latest version of the package of files configured to instantiate the TCP servers 308, 318, 330 and the TCP clients 310, 316, 324, 332 and configure the pump service communication interface 304 and the system service communication interface 306 and can store the downloaded package at a designated file location on the POS 212. At 904, the update module can verify if the signature file is valid and from a trusted source. Once determined the POS 212 can download the package of files from the designated file location and install the package of files. At 906, the POS 212 can generate and transmit a log file of the installation (or an upgrade) and provide the log file to the 3PCD. At 908, the POS 212 can execute the installed package to instantiate the pump service communication interface 304 and the system service communication interface 306.

### Messaging via the Pump and System Services Communication Interfaces

The aforementioned sequence dataflow diagrams and corresponding data exchange described herein via the pump service communication interface 304 and the system service communication interfaces 306 can be implemented using TCP/IP communication protocols and a Java-script Object Notation (JSON) messaging schema. The POS 212 can include client functionality 310 and 316 that is configured to establish and maintain a communicable connection to the pump controller 120 and the payment mechanism 134 via the pump service communication interface 304 and the system service communication interface 306, respectively. If the connection is broken, the POS 212 can be responsible for re-establishing the connection by connecting to the TCP server 308 providing the pump service communication interface 304 or to the TCP server 318 providing the system services communication interface 306. The TCP servers 308, 318 can be configured to listen for incoming connection requests to connect with the POS 212 on a port number configured in a configuration file.

The messages exchanged via the pump and system service communication interfaces 304, 306 and the various clients 310, 316, 324, 332 can include a JSON message having a predetermined message length. In some embodiments, the message can include a 4-byte message prefix. The prefix can be in network byte order and can specify the number of bytes in the JSON message that follows the prefix. In some embodiments, the byte stream synchronization can be managed, but in the event synchronization of the byte stream is lost, the connection can be closed and re-established.

The message format should be a valid JSON format and confirm to the JSON schema described herein. In some embodiments, messages longer than 4096 bytes are not supported. The message format can be as follows:

```
{
  “header”: “string”,
  “sequenceNumber”: “string”,
  “messageType”: “string”,
  “messageBody”: object,
  “timestamp”: “string”,
  “mac”: “string”
}
```

The messages can define the input/output messages exchanged over the TCP/IP services established between the POS 212 and the product dispenser 112. The message can include a number of properties. For example, a header of the messages can be reserved for future use and can define a protection level of the message body. The message body can be sent over TCP/IP as encoded, encrypted, plain-text and the header can have an algorithm for decoding/decrypting the message body. The header can be hard coded to “0x00.” The sequence number of the messages can provide a reference for tracking and sequencing the requests and responses exchanged between the various components described herein. For requests and responses, the POS 212 can be configured to track a sequence of message. For events, the sequence number can be empty. The message type of the messages can define a type of the message body. The message type can be used to de-serialize the message body as the target object. The message body of the messages can define and include the data of the message. The message body can be serialized from an underlying type as defined in the message type. The timestamp of the messages can define the time the message was created and the message authentication code (MAC) of the messages can be configured to verify the integrity of the message. For example, the MAC can be a checksum, a cyclic redundancy check (CRC), or the like. The MAC can be sensitive to any change in the message body. The MAC can be hard coded to “0x00.”

In some embodiments, once the pump service communication interface 304 or system service communication interface 306 is established with the POS 212, then peers of the POS 212 can use a heartbeat message to keep the connection alive. Any request or response from/to a peer can be a heartbeat. If a socket is open and the heartbeat message is missed more than a predetermined number of times, the pump service or the system service will close the socket connection. The heartbeat message format can be as follows:

```
{
  “header”: “0x00”,
  “sequenceNumber”: “”,
  “timestamp”: “2024-05-02T14:50:09.517-05:00”,
  “messageType”: “HeartbeatEvent”,
  “messageBody”: { },
  “mac”: “0x00”
}
```

The message schema can be utilized for pump service functionality with respect to authorizing, deauthorizing, resuming, suspending, starting, or stopping operation of the product dispenser 112. For example, authorization can authorize the pump controller 120 to select a grade of a product to be dispensed and to start dispensing. The POS 212 can transmit an authorization request only after authorizing payment from a user/customer. The authorization request can apply a limit on the dispensed product based on an amount of the product to be dispensed or a volume of product to be dispensed. The authorization request can authorize the product dispenser 112. In some embodiments, the product dispenser 112 can dispense in a suspended mode. The product will not be dispensed until the POS 212 sends a “resume” request after the grade has been selected by a user/customer. If the product dispenser 112 is already in an authorized state, the pump service can return a failure response with a predetermined status or error code. The authorization request can be formatted as follows:

```
{
  “header”: “0x00”,
  “sequenceNumber”: “125”,
  “messageType”: “AuthorizeRequest”,
  “messageBody”: {
    “amount”: 2000,
    “volume”: 0,
    “priceMode”: “Credit”
  },
  “timestamp”: “2024-05-02T14:50:09.517-05:00”,
  “mac”: “0x00”
}
```

The authorization request can include an amount for a dispensing point of the product dispenser 112 to be authorized. The units of the amount can be cents, e.g., $0.01 and the volume attribute must be set to 0 if the amount attribute is specified. The authorization request can also include a volume of the product dispensed from the dispensing point of the product dispenser 112. The units of the volume can be gallons. The amount attribute must be set to 0 if the volume is specified. In some embodiments, a minimum volume must be specified. This can be useful in situations where loyalty program discounts are only valid up to a certain volume limit. The authorization request can also include a price mode. Each grade of dispensed product can include two prices, one for cash and one for credit. The POS 212 can set different prices on the dispensing point of the product dispenser 112 for each grade of dispensed product. If the same price is used for cash and credit on each grade of the dispensed fuel or no price mode is input, then the price mode value can be set to credit by default.

The authorization request can be validated in a number of ways. For example, in some embodiments, either the sales amount or the volume of the dispensed product must be specified in the message and the sales amount or the volume must be a non-zero integer value. In some embodiments, if both of the sales amount and the volume are non-zero integers in the message, the TCP server 308 associated with the pump service communication interface 304, will be configured to just utilize the integer value of the sales amount and will disregard the integer value of the volume of the dispensed product.

The authorization request response message can have the following format:

```
{
  “header”: “0x00”,
  “sequenceNumber”: “1”,
  “timestamp”: “2024-05-02T14:50:09.517-05:00”,
  “messageType”: “AuthorizeResponse”,
  “messageBody”: {
    “serviceStatus”: {
      “statusCode”: 100000,
      “success”: true
    }
  },
  “mac”: “0x00”
}
```

The response will be successful when the TCP server 308 sets a delivery limit on the pump controller 120 and authorizes the pump controller 120. If one of the two operations is unsuccessful, then a failure response message can be generated with a predetermined status/error code. In some embodiments, the description field can be an optional attribute. An exemplary failure response message can be as follows:

```
{
  “header”: “0x00”,
  “sequenceNumber”: “1”,
  “timestamp”: “2024-05-02T14:50:09.517-05:00”,
  “messageType”: “AuthorizeResponse”,
  “messageBody”: {
    “serviceStatus”: {
      “statusCode”: 103010,
      “success”: true,
      “description”: “IGEM is already in authorized state”
    }
  },
  “mac”: “0x00”
}
```

A deauthorization request can deauthorize the pump controller 120. For example, the POS 212 can send a deauthorization request when a product dispenser 112 is in an authorized mode and a user/customer wants to cancel the dispensing transaction before product dispensing has begun. If product dispensing is already in progress and the POS 212 can send a deauthorization request, the TCP server 308 can send a failure response message from the pump controller 120 to the POS 212 with a predetermined status/error code. If the product dispenser 112 is already in a deauthorized state or mode and the POS 212 can send the deauthorization request, the TCP server 308 can send the success response message from the pump controller 120 to the POS 212 with a predetermined status/error code. In some embodiments, the message body can be empty. The deauthorization request can be as follows:

```
{
  “header”: “0x00”,
  “sequenceNumber”: “1”,
  “timestamp”: “2024-05-02T14:50:09.517-05:00”.
  “messageType”: “DeauthorizeRequest”,
  “messageBody”: { },
  “mac”: “0x00”
}
```

A response will be successful when the TCP server 308 deauthorizes the pump controller 120. If the operation fails, an appropriate failure response can be returned with a predetermined status/error code. A response to the deauthorization request can be as follows:

```
{
  “header”: “0x00”,
  “sequenceNumber”: “1”,
  “timestamp”: “2024-05-02T14:50:09.517-05:00”,
  “messageType”: “DeauthorizeResponse”,
  “messageBody”: {
    “serviceStatus”: {
      “statusCode”: 100000,
      “success”: true
    }
  },
  “mac”: “0x00”
}
```

A resume request can resume a suspended pump controller 120. The POS 212 can send a resume request when a product dispenser 112 is in a suspended mode or state. An authorization request can apply limits on the dispensed product based on an amount of the dispensed product or a sales amount and can authorize the product dispenser 112 to operate in a suspended mode or state. Once a user/customer has selected a product grade of the dispensed product, the POS 212 can validate the product grade. If the grade is valid (e.g., not restricted to fleet vehicles or vehicles requiring a particular product grade), the POS 212 can provide the resume request to start dispensing the product. If product dispensing is suspended (e.g., by sending a suspend request), and the POS 212 wants to resume dispensing the product, the POS 212 can send the resume request to resume dispensing the product. If the product dispenser 112 is already in a resume mode or state and the POS 212 can send a resume request, the TCP server 308 can send the success response to the POS 212 from the pump controller 120 with a predetermined status/error code. In some embodiments, the message body can be empty. The resume request can be as follows:

```
{
  “header”: “0x00”,
  “sequenceNumber”: “1”,
  “timestamp”: “2024-05-02T14:50:09.517-05:00”,
  “messageType”: “ResumeRequest”,
  “messageBody”: { },
  “mac”: “0x00”
}
```

The response to resume request will be successful when the pump service resumes the pump controller 120 operation. If the operation fails, a failure response with a predetermined error/status code will be returned. The response to the resume request can be as follows:

```
{
  “header”: “0x00”,
  “sequenceNumber”: “1”,
  “timestamp”: “2024-05-02T14:50:09.517-05:00”,
  “messageType”: “ResumeResponse”,
  “messageBody”: {
    “serviceStatus”: {
      “statusCode”: 100000,
      “success”: true
    }
  },
  “mac”: “0x00”
}
```

A suspend request can suspend a pump controller 120 that has been started. If product dispensing is in progress and the POS 212 wants to stop the dispensing of the product, the POS 212 can send a suspend request to the pump controller 120. If the product dispenser 112 is already in a suspend mode and the POS 212 can send a suspend request, the pump controller 120 can send the success response to the POS 212 via the pump communication interface 304 with a predetermined error/status code. In some embodiments, the message body of the suspend request can be empty. The suspend request can be as follows:

```
{
  “header”: “0x00”,
  “sequenceNumber”: “1”,
  “timestamp”: “2024-05-02T14:50:09.517-05:00”,
  “messageType”: “SuspendRequest”,
  “messageBody”: { },
  “mac”: “0x00”
}
```

A response to the suspend request can be successful when the pump service suspends the pump controller 120. If the operation fails, a failure response can be provided with a predetermined error/status code. The response to the suspend request can be as follows:

```
{
  “header”: “0x00”,
  “sequenceNumber”: “1”,
  “timestamp”: “2024-05-02T14:50:09.517-05:00”,
  “messageType”: “SuspendResponse”,
  “messageBody”: {
    “serviceStatus”: {
      “statusCode”: 100000,
      “success”: true
    }
  },
  “mac”: “0x00”
}
```

A stop request can stop a pump controller 120 that has been previously started. The stop can include a hard stop that disables a pump motor of the product dispenser 112 from dispensing product further. If the product dispenser 112 is already in a stop state or mode, and the POS 212 can send a stop request, the pump controller 120 can send a success response to the POS 212 via the pump service communication interface 304 with a predetermined status code. In some embodiments, the message body can be empty. The stop request can be as follows:

```
{
  “header”: “0x00”,
  “sequenceNumber”: “1”,
  “timestamp”: “2024-05-02T14:30:09.517-05:00”,
  “messageType”: “StopRequest”,
  “messageBody”: { },
  “mac”: “0x00”
}
```

A response to the stop request can be successful when the pump service stops the pump controller 120 from dispensing product. If the operation fails, a failure response can be returned with a predetermined error/status code. The response to the stop request can be as follows:

```
{
  “header”: “0x00”,
  “sequenceNumber”: “1”,
  “timestamp”: “2024-05-02T14:50:09.517-05:00”,
  “messageType”: “StopResponse”,
  “messageBody”: {
    “serviceStatus”: {
      “statusCode”: 100000,
      “success”: true
    }
  },
  “mac”: “0x00”
}
```

Some functionality of the TCP server 318 associated with the system service communication interfaces 306 can be implemented during initial start-up and configuration. For example, the TCP server 318 can execute a number of start-up actions, such as a LAN2 interface settings update, a pairing configuration for the payment mechanism 134, and a communication endpoint for the POS 212. The start-up actions can include a set of checks and updates each time the system service starts to ensure the payment mechanism 134 can have the most recent versions of software configured thereon. Once the start-up actions have been completed, the system service can transition to operational mode.

The LAN2 interface settings update can be configured for Linux® operating systems and can be configured to set the LAN2 interface settings (e.g., the IP address, the subnet mask, and gateway) to match values from a configuration file. If the settings do not match, the system service will attempt to change the settings to match those specified in the configuration file.

The pairing configuration for the payment mechanism 134 can verify that the payment mechanism 134 has the desired network interface settings as specified in the configuration file. If the payment mechanism 134 has different network interface settings from a previous start-up, the payment mechanism 134 can be sent a command to update the network interface settings and restart the payment mechanism 134. The pairing configuration of the network interface settings can be checked after restart and can be repeated until the expected values are received from the payment mechanism 134.

The communication endpoint for the POS 212 can start a TCP service that can allow the POS 212 to send commands via the system service communication interfaces 306 and can receive responses via the same.

In operational mode, following the aforementioned start-up functionality, the POS 212 via the TCP server 318 can be configured to provide file replication or updating. Once the POS 212 connects successfully to the payment mechanism 134, a process of file replication can be initiated. The POS 212 and/or the TCP server 318 can maintain a copy of executable and configuration files that are expected to be configured on the payment mechanism 134. The file replication process in the system service can exchange messages with a counterpart function in the payment mechanism 134 to determine whether or not the set of executable and configuration files on the payment mechanism 134 matches the set of executable and configuration files in the POS 212. If differences exist, the POS 212 can transfer the missing or updated files to the payment mechanism 134. The payment mechanism 134 can then apply the changes in the executable and configuration files it maintains. The payment mechanism 134 can then restart, depending on the nature of the changes made.

### Product Dispenser Embodiments

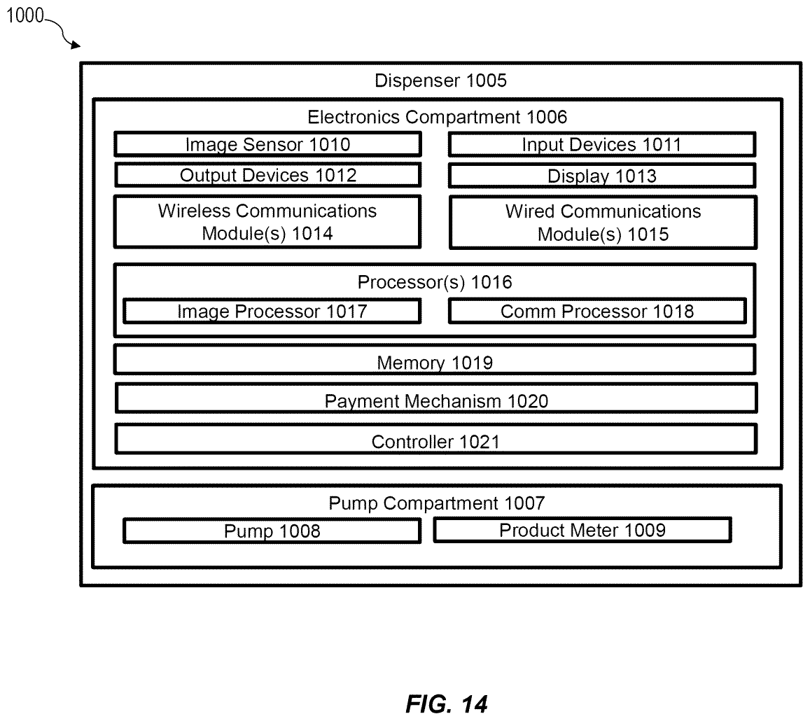

FIG. 14 is a block diagram illustrating one embodiment 1000 of a product dispenser 1005, such as the product dispenser 112 included in the system 100 shown in FIG. 1. The product dispenser 112 can be configured to exchange data with a dispenser user, a vehicle, and/or a computing device associated with the dispenser user. The product dispenser 1005 can perform operations that include, but are not limited to, receiving inputs related to selecting products available via the product dispenser 1005, performing dispensing transactions, exchanging loyalty program data with users, displaying graphical and textual content associated with goods and services available within the dispensing environment, and receiving user inputs regarding the available goods and services.

As shown in FIG. 14, the product dispenser 1005 can include an electronics compartment 1006 and a pump compartment 1007. The electronics compartment 1006 can contain therein electronics for facilitating payment for dispensed products, such as fuel, and for facilitating dispensing of the dispensed products. In some embodiments, the electronics can facilitate payment for goods and services available within the dispensing environment, including but not limited to a food item, a beverage, a parking space, a pharmacy item, groceries to be delivered, a car wash, a tire pressure check, public transit, and the like. The electronics compartment 1006 can include an image sensor 1010, data processor(s) 1016, wireless module(s) 1014, wired communications module(s) 1016, input devices 1011, output devices 1012 and a memory 1019 or similar non-transitory storage medium configured to store computer-readable and executable instructions, which when executed by the processor 1016 perform operations of the dispenser 1005 described herein.

The image sensor 1010 can include a thermochromic camera, an infrared camera, a digital still camera, or a video camera, although other optical sensors are possible. In some embodiments, the image sensor 1010 can be affixed to an exterior surface of the dispenser 1005. In some embodiments, the image sensor 1010 can be configured within the dispensing environment and communicably coupled to the processors 1016. The input devices 1011 can include an alphanumeric keypad, a numeric keypad, a microphone, or the like. The output devices 1012 can include a speaker, a printer, or the like.

The display 1013 can be capable of providing information to a user of the dispenser 1005. The display 1013 can have a variety of configurations, such as a cathode ray tube (CRT) screen, a liquid crystal display (LCD) screen, a light emitting diode (LED) screen, a touchscreen, and the like. For example, the display 1013 can include a single display. Alternatively, the display 1013 can include multiple displays. For example, a first display 1013 can be on a front side of the dispenser 1005 and a second display 1013 can be on a back side of the dispenser 1005. As another example, the display 1013 can include two displays mounted next to each other to increase an overall display size. As yet another example, the display 1013 can include first and second displays mounted next to each other on a front side of the dispenser 1005 and can include third and fourth mounted next to each other on a back side of the dispenser 1005.

The communications modules, such as either of the wireless communications module(s) 1014 or the wired communications module(s) 1015 are capable of exchanging data between the dispenser 1005 and computing devices communicably coupled to the dispenser 1005. For example, in some embodiments, the wireless communication module(s) 1014 can be capable of communicating or exchanging data wirelessly with a remote system (e.g., a remote cloud server, a third-party payment authorization system, etc.) utilizing a variety of communication protocols, e.g., TCP/IP, etc. In some implementations, the wireless communication module(s) 1014 can be capable of facilitating wireless communication over a short-range communication link. For example, the wireless communication module(s) 1014 can include a transceiver configured to communicate via any of a variety of short-range wireless techniques, such as a Bluetooth protocol, a Wi-Fi protocol, near field communication (NFC), an ultra-wideband (UWB) protocol, a radio frequency identification (RFID) protocol, etc. Any of a variety of types of wireless connectivity hardware can be used for the short-range wireless connectivity, as will be appreciated by a person skilled in the art. The types of wireless connectivity that the wireless communication module(s) 1014 includes can be chosen by an owner of the dispensing environment 11 according to the owner's current dispensing site setup and/or future dispensing environment plans, and the wireless communication module(s) 1014 may be manufactured and/or updated accordingly.

In some embodiments, the wireless module(s) 1014 can operatively connect the product dispenser 1005 with another computing device. The wireless module 1014 can include, e.g., a transceiver communicating via Bluetooth protocol, cellular protocol, WIFI protocol, near field communication (NFC), and/or a radio frequency identification (RFID) protocol. IN some embodiments, the wireless communications module 1014 can operatively connects the product dispenser 1005 with a remote server.

In some embodiments, the wired communication module(s) 1015 can be configured to communicate or exchange data over a wired connection in addition to or instead of over a wireless connection. A wired connection can be used, for example, for a local communication link between the product dispenser 1005 and a local computing system external to the product dispenser 1005 (e.g., a forecourt controller, an in-store a point of sale (POS) device, etc.). A wired connection may provide more security and/or stability than a wireless connection and/or may allow a legacy product dispenser 1005 configured to communicate only via one or more wired connections to implement dynamic management of content provided via the display 1013. Wired communication can occur via any of a variety of wired communication protocols, e.g., TCP/IP, etc., as will be appreciated by a person skilled in the art. Some product dispensers 1005 are manufactured with two-wire connectivity, and the wired communication can accordingly be via two wires, such as via a controller area network bus (e.g., a CAN Bus) two wire connection, an RS485 two wire connection, a current loop connection, or other type of two wire connection. Some product dispensers 1005 are additionally or alternatively manufactured with cable connectivity and can accordingly be configured to provide wired communication via cable connection, such as an Ethernet cable or other network cable. Older product dispensers typically have two-wire connectivity capabilities while newer product dispensers 1005 typically have Ethernet connectivity capabilities instead.

The processor(s) 1016 can include one or more processors forming part of at least one computing system. In one embodiment, the processor(s) 1016 include at least an image processor 1017 and a communications processor 1018 (e.g., a Comm Processor 1018) as shown in FIG. 14. An image processor 1017 can receive one or more images from the image sensor 1010 and determine identity information of a customer using the images. Identity information can include, for example, facial feature of a customer, a vehicle feature, a license plate number, a non-facial body feature, and the like. The image processor 1017 can receive an image from image sensor 1010, for example, when the product dispenser 1005 detects that a customer or user is proximate to the product dispenser 105 and/or is in the field of view of the image sensor 1010. The image can be of the customer (e.g., the image can contain a visual representation of the customer) and/or the customer's vehicle, for example. The image processor 1017 is capable of performing operations, including but not limited to, receiving image data, and identifying physical characteristics of the user or a vehicle to determine regions within the image data in which the customer's face, body, and vehicle reside.

Using these regions, one or more image features related to the customer's face, body, and vehicle. For example, a facial feature can include skin texture; relative position, size, and/or shape of the eyes, nose, cheekbones, and jaw; and the like. Body features can include height, weight, hair color, body shape, and the like. Vehicle features can include shape, color, license plate number, manufacturer/make/model decal, and the like.

In at least some implementations, the image processor 1017 is capable of classifying aspects of the image data as a vehicle, a non-facial body part, and/or a safety object or event. For example, the image processor 1017 can classify (or determine) characteristics of the customer's vehicle based on the vehicle features. These characteristics can include, for example, license plate number, vehicle make, required grade and/or type of fuel for the vehicle, and vehicle model.

The image processor 1017 is also capable of classifying (or determining) characteristics of the customer that do not directly derive the customer's identity based on the non-facial body features. For example, the image processor 1017 is capable of determining a customer's height, weight age, gender, disability status (e.g., in a wheelchair or not in a wheelchair, etc.), and the like.

The image processor 1017 is further capable of classifying (or determining) behavior of the customer that relates to safety and is based on an extracted feature present within the image data. For example, the image processor 1017 can determine whether the customer is smoking, whether the customer is grounded prior to dispensing products or fuel, whether the vehicle engine is running during fueling, and whether the customer is about to “drive-off” (which can include leaving the fuel retailer without paying for dispensed products or fuel and/or leaving the fueling retailer with a nozzle of the product dispenser 1005 still coupled to the vehicle). Other determinations can include environmental, mechanical, electrical, and/or logical instruction conditions, such as, for example, temperature, pressure, humidity, fuel leaks, open panels, dispenser intrusion, power irregularities, watchdog timer expiration, and software exceptions.

Based on these classifications, the image processor 1017 is capable of generating an alarm. The alarm can include a warning (e.g., signal, audio, light, and the like) to an attendant of the dispensing environment 110, such as at a site of the product dispenser 1005. The warning can include an audible sound emanating from the dispenser 1005, a visual or graphical warning on the display 1013 of the product dispenser 1005 indicating that products cannot be dispensed until the detected problem is corrected, and the like. Generating the alarm can include causing a corrective action to be performed, for example, restarting the dispenser 1005 (e.g., in the event that a mechanical, electrical, and/or logical problem with the dispenser 1005 is detected by the image processor 1017), shutting down the product dispenser 1005 (e.g., in the event that an unsafe condition is detected by the image processor 1017, such as the customer smoking before or during fueling, the customer not being grounded prior to dispensing fuel or products, the vehicle engine running during fueling, or a mechanical, electrical, and/or logical problem with the product dispenser 1005 being detected that cannot be fixed without manual intervention), downloading instructions for the product dispenser 1005 (e.g., to correct a mechanical, electrical, and/or logical problem with the dispenser 1005), and/or generating notifications for other components at the fueling facility that includes the dispenser 1005 (e.g., in the event an unsafe condition is detected by the image processor 1017 that may affect safe functioning one or more other product dispensers 1005 within the dispensing environment).

In at least some implementations, image data including the facial features of a user or customer can be conveyed via the dispenser's communications module(s), such as the wireless module(s) 1014 and/or the wired communications module(s) 1015 to a remote server.

The user profile and/or identity may be received by the communications processor 1018 and can be stored in the memory 1019. The user profile can be used by the communications processor 1018 to provide a customized product dispensing experience. For example, the user profile can be accessed and the product dispenser 1005 can be configured with the customer's preferences. This can include rendering, on the display 1013, a preference selection screen populated with the customer's dispensing preferences as specified in the user profile. In at least some implementations, the product dispenser 1005 can render a personalized greeting on the display 1013.

In at least some implementations, identity information can be received by the communications processor 1018. The identity information can include a name or unique identifier of the customer. This identity information can be used by the communications processor 1018 to acquire the user profile from the remote server. In at least some implementations the identity information can include, for example, facial features of the customer, vehicle features, license plate number, non-facial body features, and the like.

As further shown in FIG. 14, the electronics compartment 1006 can also include a payment mechanism 1020 (e.g., a pin pad, a card reader, a Near Field Communication (NFC) module, etc.) configured to facilitate payment for dispensed products, such as fuel, (or other goods and services). The payment mechanism 1020 can be configured to receive inputs such as, e.g., user identification information and/or payment information, and deliver the information to the controller 1021. For example, the payment mechanism 1020 can include a barcode and/or QR code scanner, and/or an NFC contactless card reader for receiving payment information, user identification information, vehicle information, and/or loyalty program information.

The electronics compartment 1006 can also include a controller 1021 configured to receive instructions from the processor(s) 1016 and generate one or more control signals controlling operations of components of the product dispenser 1005 in accordance with the operations described herein. In some embodiments, the controller 1021 can include a data processor and a memory storing computer-readable and executable instructions, forming part of at least one computing system within the electronics compartment 1006. In some embodiments, controller 1021 can be operably coupled to components of the electronics compartment 1006, such as the display 1013, the image sensor 1010, the wireless communication module(s) 1014, the wired communication module(s) 1015, the processor(s) 1016, the memory 1019, and the payment mechanism 1020, and the controller 1021 can be configured to control operations thereof. In some embodiments, the controller 1021 can be configured as the pump controller 120 shown in FIG. 3 and can be operatively coupled to components of the pump compartment 1007, such as the pump 1008 or the product meter 1009. The pump controller 1021 can generate control signals controlling operations of the pump 1008 or the product meter 1009.

The pump compartment 1007 houses a pump 1008 configured to provide a liquid dispensed product, such as fuel, from a storage tank or other reservoir. The pump compartment 1007 can also include one or more product meters 1009 that can be configured to monitor flow of dispensed products, flow of additives added to the dispensed product, and/or flow of other components of the dispensed product fuel. The pump compartment 1007 can also include other components to facilitate product dispensing and mixing, such as motors and valves, a strainer/filtering system, a vapor recovery system, and the like. The pump compartment 1007 is isolated from the electronics compartment 1006 within the product dispenser 1005 to facilitate safety, security, and/or maintenance, as will be appreciated by a person skilled in the art. Dispensed products do not flow or are not conveyed from the pump compartment 1007 to the electronics compartment 1006 and instead the dispensed products, such as fuel, flow or otherwise are conveyed through the pump compartment 1007 to a dispensing device of the product dispenser 1005, such as a hose and a nozzle at an end of the hose. The dispenser 1005 can include any number of hoses and associated nozzles.

A person skilled in the art will appreciate that the product dispenser 1005 can have various other configurations. Various exemplary implementations of product dispensers and methods of provisioning software thereto are described further in, for example, U.S. Pat. No. 10,214,411 entitled “Fuel Dispenser Communication” issued Feb. 26, 2019; U.S. Pat. No. 10,269,082 entitled “Intelligent Fuel Dispensers” issued Apr. 23, 2019; U.S. Pat. No. 10,577,237 entitled “Methods And Devices For Fuel Dispenser Electronic Communication” issued Mar. 3, 2020; U.S. Pat. No. 10,726,508 entitled “Intelligent Fuel Dispensers” issued Jul. 28, 2020; U.S. Pat. No. 11,276,051 entitled “Systems And Methods For Convenient And Secure Mobile Transactions” issued Mar. 15, 2022; U.S. Pat. No. 11,429,945 entitled “Outdoor Payment Terminals” issued Aug. 30, 2022; U.S. Pat. No. 11,443,582 entitled “Virtual Payment System and Method for Dispensing Fuel” issued Sep. 13, 2022; U.S. Pat. App. Pub. No. 2023/0196360 entitled “Conducting Fuel Dispensing Transactions” published Jun. 22, 2023, and U.S. Pat. App. Pub. No. 2023/0103400 entitled “Intelligent Electronic Fueling Station Component Provisioning” published Apr. 6, 2023, each of which are hereby incorporated by reference in their entireties.

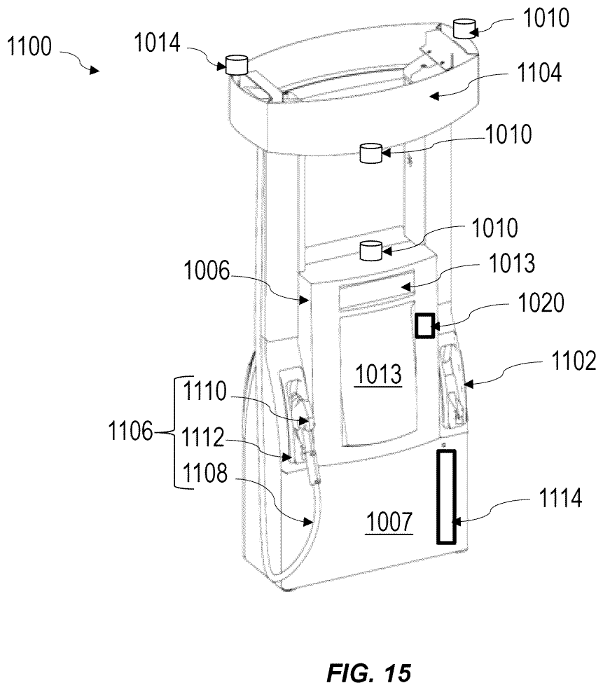

FIG. 15 illustrates a perspective view of one embodiment of a product dispenser 1100. The product dispenser 1100 is an embodiment of product dispenser 1005 of FIG. 13. The product dispenser 1100 can be configured to dispense liquid products (e.g., petroleum fuel). For example, in some embodiments, the product dispenser 1100 can be configured to dispense liquid products such as gasoline, diesel fuel, ethanol-based fuels, biofuels, diesel exhaust fluid (DEF), fuel additives (e.g., acetone, ether, nitrous oxide, nitromethane, butyl rubber, ferox, oxyhydrogen), water and the like.

As shown in FIG. 15, the product dispenser 1100 can include a dispenser body 1102 in which the electronics compartment 1006 and the pump compartment 1007 are configured. The product dispenser 1100 can also include a dispenser awning 1104 coupled to the dispenser body 1102. In some embodiments, the dispenser body 1102 can exclude the dispenser awning 1104. The dispenser awning 1104 can include at least one image sensor 1010 and at least one wireless transmission module 1014 configured thereon. In some embodiments, the dispenser body 1102 can, additionally or alternatively, include an image sensor 1010. As further shown, the dispenser body 1102 can include a display 1013, a payment mechanism 1020, and a dispensing assembly 1106.

The dispenser body 1102 can include an electronics compartment 1006 and a pump compartment 1007. The pump compartment 1007 is isolated from the electronics compartment 1006 within the dispenser 1005 to facilitate safety, security, and/or maintenance, as will be appreciated by a person skilled in the art. Dispensed products or fuel is thus not allowed to flow from the pump compartment 1007 to the electronics compartment 1006 and instead flows from the pump compartment 1007 to the dispensing assembly 1106. The dispensing assembly 1106 can include a hose 1108 coupled to a nozzle 1110 for dispensing the liquid product. As will be appreciated by a person skilled in the art, the nozzle 1110 can be configured to dispense the liquid product from the dispenser 1005 as pumped therefrom by the pump 1008. The dispensing assembly 1106 can also include a nozzle receptacle 1112 configured to store the nozzle 1110 when not in use. In some embodiments, the product dispenser 1100 can include 1, 2, 3, 4, 5, or 6 dispensing assemblies 1106. The dispensing assemblies 1106 can also be referred to as dispensing points. In some embodiments, one or more first dispensing assemblies 1106 can be provided on a first side of the product dispenser 1100 and one or more second dispensing assemblies 1106 can be provided on a second side of the product dispenser 1100 that is opposite the first side of the product dispenser 1100.

In some embodiments, the product dispenser 1100 can be configured to dispense diesel exhaust fluid (DEF) and can include a heater 1114 within the pump compartment 1007 of the dispenser body 1102. The heater 1114 can be configured to heat the DEF and portions of the pump compartment 1007 and/or dispensing assemblies 1106. Heating components of the dispenser 1100 can be advantageous in climates where freezing temperatures are a concern.

In some implementations, the product dispensers described herein can be configured to other types of dispensed products, in addition to or instead of a liquid dispensed product. For example, the dispenser can be configured to dispense products in a gaseous format, such as hydrogen, compressed natural gas (CNG), liquified natural gas (LNG), electricity, or the like. It will be understood that the dispensing environments, dispensing systems, and the dispensers described herein are not limited to dispensing products in liquid format and that the dispensing environments, dispensing systems, and the dispensers described herein can, additionally or alternatively, be configured to dispense products in non-liquid product formats, such as a vapor, a gas, or electricity. For example, in some implementations, the dispenser 1100 can be a hydrogen dispenser. As another example, in some implementations, the product dispenser 1100 can be a compressed natural gas dispenser. As yet another example, in some implementations, the product dispenser 1100 can be an electrical fuel dispenser configured to dispense electricity.

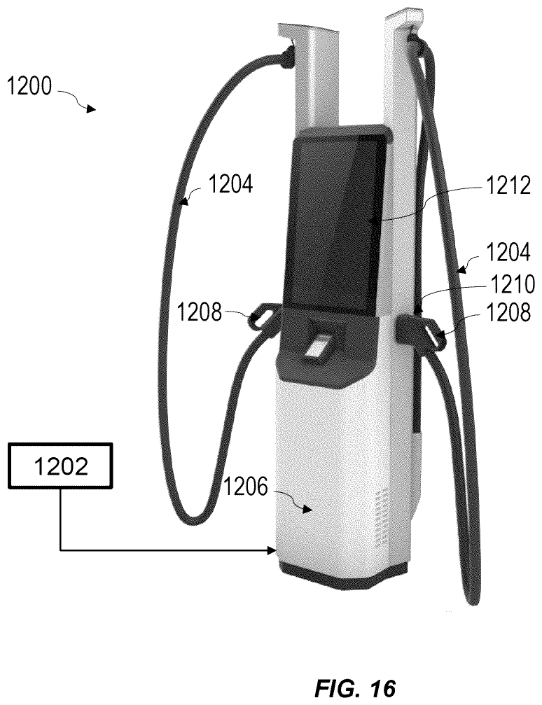

The dispenser 1200 of FIG. 16 is another embodiment of the product dispenser 1005 and 1100 of FIGS. 1, 14, and 15 except where noted otherwise. The product dispenser 1200 can be configured to dispense electricity. For example, the product dispenser 1200 can be configured as an electric vehicle charger. The product dispenser 1200 can be operatively coupled to a power supply 1202, such as a local or regional power grid, a battery-back up power supply, a retail sales facility, or a vehicle service facility located in proximity of the product dispenser 1200.

The product dispenser 1200 can include a charging cable 1204 coupled to a dispenser body 1206 of the product dispenser 1200. In some embodiments, the product dispenser 1200 can include multiple charging cables 1204 as shown in FIG. 16 and is not limited to a configuration having a single charging cable 1204. The charging cable 1204 can be configured to deliver electricity to a charging connector 1208. In some embodiments, the charging connector 1208 can be referred to as a dispensing point. The charging connector 1208 can be configured to couple to a charging port of a vehicle and to deliver the electricity provided by the product dispenser 1200, via the charging cable 1204, to the vehicle when the charging connector 1208 is coupled to the vehicle charging port. When not in use, the charging connector 1208 is configured to be stored in a charger receptacle 1210 formed on the dispenser body 1206. In some embodiments, the display 1212 can be configured to display a dispensed volume of electricity in kilowatt hours. In some embodiments, the display 1212 can display a user interface indicating that charging will commence or that charging is in process. In some embodiments, the product dispenser 1200 can include an EV charger controller in place of the pump controller 1021.

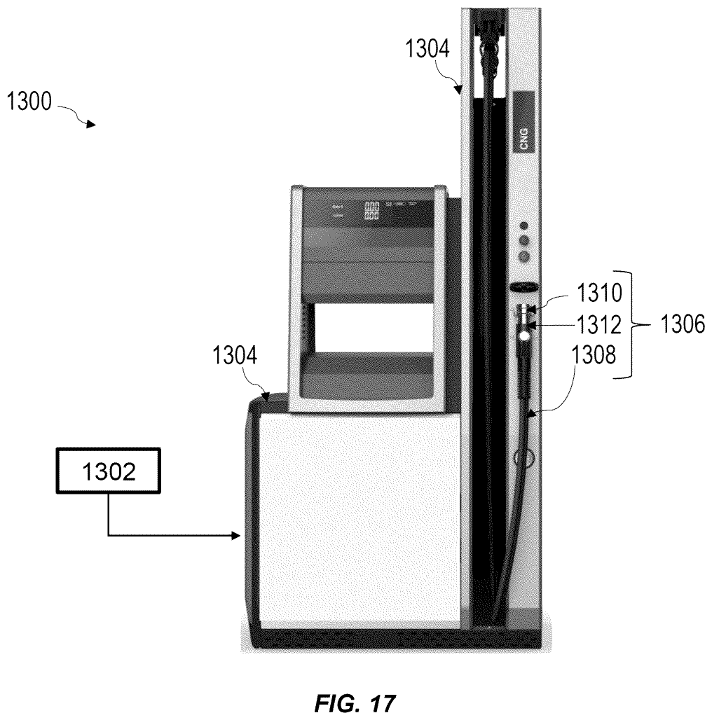

The product dispenser 1300 shown in FIG. 17 is another embodiment of the product dispenser 1005 and 1100 of FIGS. 1, 14, and 15 except where noted otherwise. The product dispenser 1300 can be configured to dispense gaseous products such as compressed natural gas (CNG). In some embodiments, the product dispenser 1300 can alternatively be configured to dispense, liquified petroleum gas (LPG), hydrogen, and liquified natural gas (LNG). For example, the product dispenser 1300 can be operatively coupled to a gas supply 1302 of CNG or other gaseous product, such as a local or regional pipeline, a stored gas supply located within the dispensing environment with the product dispenser 1300, or a mobile tube trailer in proximity of the product dispenser 1300.

The product dispenser 1300 can also include one or more dispensing assemblies 1306 configured within the dispenser body 1304. The dispensing assemblies 1306 can also be referred to as dispensing points. The dispensing assembly 1306 can include a hose 1308 coupled to a nozzle 1310 for dispensing the gaseous CNG product. As will be appreciated by a person skilled in the art, the nozzle 1310 can be configured to dispense the CNG product from the dispenser 1300. The dispensing assembly 1306 can also include a nozzle receptacle 1312 configured to store the nozzle 1310 when not in use. In some embodiments, the dispenser 1300 can include 1, 2, 3, 4, 5, or 6 dispensing assemblies 1306. In some embodiments, one or more first dispensing assemblies 1306 can be provided on a first side of the product dispenser 1300 and one or more second dispensing assemblies 1306 can be provided on a second side of the dispenser 1300 that is opposite the first side of the product dispenser 1300.

In some embodiments, the product dispensers described herein can be configured to dispense multiple product types. For example, a first portion of a product dispenser including a first dispensing assembly can be configured to dispense a liquid product, such as petroleum or DEF, and a second portion of the same product dispenser can include a second dispensing assembly configured to dispense a non-liquid product, such as electricity or a gaseous product, such as CNG, LNG, LPG, or Hydrogen. A variety of combinations of dispensing portions and assemblies necessary to dispense multiple, different dispensed products can be envisioned within a single dispenser body of a product dispenser as described herein.

### Computing System Embodiments

FIG. 17 is a block diagram 1400 of a computing system 1410 suitable for use in implementing the computerized components described herein. In broad overview, the computing system 1410 includes at least one processor 1450 for performing actions in accordance with instructions, and one or more memory devices 1460 and/or 1470 for storing instructions and data. The illustrated example computing system 1410 includes one or more processors 1450 in communication, via a bus 1415, with memory 1470 and with at least one network interface controller 1420 with a network interface 1425 for connecting to external devices 1430. The one or more processors 1450 are also in communication, via the bus 1415, with each other and with any I/O devices at one or more I/O interfaces 1440, and any other devices 1480. The processor 1450 illustrated incorporates, or is directly connected to, cache memory 1460. Generally, a processor will execute instructions received from memory. In some embodiments, the computing system 1410 can be configured within a cloud computing environment, a virtual or containerized computing environment, and/or a web-based microservices environment.

In more detail, the processor 1450 can be any logic circuitry that processes instructions, e.g., instructions fetched from the memory 1470 or cache 1460. In many embodiments, the processor 1450 is an embedded processor, a microprocessor unit or special purpose processor. The computing system 1410 can be based on any processor, e.g., suitable digital signal processor (DSP), or set of processors, capable of operating as described herein. In some embodiments, the processor 1450 can be a single core or multi-core processor. In some embodiments, the processor 1450 can be composed of multiple processors.

The memory 1470 can be any device suitable for storing computer readable data. The memory 1470 can be a device with fixed storage or a device for reading removable storage media. Examples include all forms of non-volatile memory, media and memory devices, semiconductor memory devices (e.g., EPROM, EEPROM, SDRAM, flash memory devices, and all types of solid-state memory), magnetic disks, and magneto optical disks. A computing device 1410 can have any number of memory devices 1470.

The cache memory 1460 is generally a form of high-speed computer memory placed in close proximity to the processor 1450 for fast read/write times. In some implementations, the cache memory 1460 is part of, or on the same chip as, the processor 1450.

The network interface controller 1420 manages data exchanges via the network interface 1425. The network interface controller 1420 handles the physical, media access control, and data link layers of the Open Systems Interconnect (OSI) model for network communication. In some implementations, some of the network interface controller's tasks are handled by the processor 1450. In some implementations, the network interface controller 1420 is part of the processor 1450. In some implementations, a computing device 1410 has multiple network interface controllers 1420. In some implementations, the network interface 1425 is a connection point for a physical network link, e.g., an RJ 45 connector. In some implementations, the network interface controller 1420 supports wireless network connections and an interface port 1425 is a wireless Bluetooth transceiver. Generally, a computing device 1410 exchanges data with other network devices 1430, such as computing device 1430, via physical or wireless links to a network interface 1425. In some implementations, the network interface controller 1420 implements a network protocol such as LTE, TCP/IP Ethernet, IEEE 802.11, IEEE 802.16, Bluetooth, or the like.

The other computing devices 1430 are connected to the computing device 1410 via a network interface port 1425. The other computing device 1430 can be a peer computing device, a network device, a server, or any other computing device with network functionality. In some embodiments, the computing device 1430 can be a network device such as a hub, a bridge, a switch, or a router, connecting the computing device 1410 to a data network such as the Internet.

In some uses, the I/O interface 1440 supports an input device and/or an output device (not shown). In some uses, the input device and the output device are integrated into the same hardware, e.g., as in a touch screen. In some uses, such as in a server context, there is no I/O interface 1440 or the I/O interface 1440 is not used. In some uses, additional other components 1480 are in communication with the computer system 1410, e.g., external devices connected via a universal serial bus (USB).

The other devices 1480 can include an I/O interface 1440, external serial device ports, and any additional co-processors. For example, a computing system 1410 can include an interface (e.g., a universal serial bus (USB) interface, or the like) for connecting input devices (e.g., a keyboard, microphone, mouse, or other pointing device), output devices (e.g., video display, speaker, refreshable Braille terminal, or printer), or additional memory devices (e.g., portable flash drive or external media drive). In some implementations an I/O device is incorporated into the computing system 1410, e.g., a touch screen on a tablet device. In some implementations, a computing device 1410 includes an additional device 1480 such as a co-processor, e.g., a math co-processor that can assist the processor 1450 with high precision or complex calculations.

Certain exemplary embodiments have been described to provide an overall understanding of the principles of the structure, function, manufacture, and use of the systems, devices, and methods disclosed herein. One or more examples of these embodiments have been illustrated in the accompanying drawings. Those skilled in the art will understand that the systems, devices, and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention. Further, in the present disclosure, like-named components of the embodiments generally have similar features, and thus within a particular embodiment each feature of each like-named component is not necessarily fully elaborated upon.

The subject matter described herein can be implemented in analog electronic circuitry, digital electronic circuitry, and/or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a standalone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processor of any kind of digital computer. Generally, a processor will receive instructions and data from a read only memory or a random-access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non-volatile memory, including by way of example semiconductor memory devices, (e.g., EPROM, EEPROM, and flash memory devices); magnetic disks, (e.g., internal hard disks or removable disks); magneto optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The techniques described herein can be implemented using one or more modules. As used herein, the term “module” refers to computing software, firmware, hardware, and/or various combinations thereof. At a minimum, however, modules are not to be interpreted as software that is not implemented on hardware, firmware, or recorded on a non-transitory processor readable recordable storage medium (i.e., modules are not software per se). Indeed “module” is to be interpreted to always include at least some physical, non-transitory hardware such as a part of a processor or computer. Two different modules can share the same physical hardware (e.g., two different modules can use the same processor and network interface). The modules described herein can be combined, integrated, separated, and/or duplicated to support various applications. Also, a function described herein as being performed at a particular module can be performed at one or more other modules and/or by one or more other devices instead of or in addition to the function performed at the particular module. Further, the modules can be implemented across multiple devices and/or other components local or remote to one another. Additionally, the modules can be moved from one device and added to another device, and/or can be included in both devices.

The subject matter described herein can be implemented in a computing system that includes a back-end component (e.g., a data server), a middleware component (e.g., an application server), or a front end component (e.g., a client computer having a graphical user interface or a web browser through which a user can interact with an implementation of the subject matter described herein), or any combination of such back end, middleware, and front end components. The components of the system can be interconnected by any form or medium of digital data communication, e.g., a communication network. Examples of communication networks include a local area network (“LAN”) and a wide area network (“WAN”), e.g., the Internet.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

One skilled in the art will appreciate further features and advantages of the invention based on the above-described embodiments. Accordingly, the present application is not to be limited by what has been particularly shown and described, except as indicated by the appended claims. All publications and references cited herein are expressly incorporated by reference in their entirety.

What is claimed is:

1. A dispenser, comprising:
a point-of-sale (POS) application;
a pump controller operably coupled to the POS application via a first communication interface configured to exchange pump service data with the POS application, the first communication interface configured to exchange the pump service data via a first virtualized TCP server communicably coupling the pump controller to the POS application; and
a payment mechanism including a payment data processor operably coupled to the POS application via at least one second communication interface configured to exchange system service data with the POS application, the at least one second communication interface configured to exchange the system service data via a second virtualized TCP server communicably coupling the payment data processor and the POS application, the pump service data and the system service data generated by the POS application responsive to one or more operations performed at the dispenser.

2. The dispenser of claim 1, wherein the at least one second communication interface is configured to exchange the system service data in an EMV data format.

3. The dispenser of claim 1, wherein a portion of the at least one second communication interface is configured to exchange the system service data in an encrypted data format.

4. The dispenser of claim 1, wherein a portion of the first communication interface is configured to exchange the pump service data in a CAN bus data format.

5. The dispenser of claim 1, wherein the first and second virtualized TCP servers are configured to exchange the pump and system service data via TCP data packets including JSON formatted messages.

6. The dispenser of claim 1, wherein the POS application is installed on the dispenser and configured for use by a third-party different than a manufacturer of the dispenser, the POS application enabling pump and system service data exchange for the one or more operations performed at the dispenser that are customized for the third party.

7. The dispenser of claim 1, wherein the pump service data includes data characterizing at least one of configuration data of the pump controller, a software or a firmware update of the pump controller, telemetry data associated with the pump controller, diagnostic data associated with the pump controller, and log file data associated with the pump controller.

8. The dispenser of claim 1, wherein the pump service data is generated responsive to the one or more operations performed at the dispenser including at least one of authorizing, deauthorizing, starting, stopping, suspending, and resuming the dispenser.

9. The dispenser of claim 1, wherein the pump service data is generated responsive to one or more pump service events associated with the one or more operations of the dispenser, the one or more events pump service including at least one of a state change of the pump controller, a status change of the pump controller, a current total volume of a dispensed product generated by the pump controller, a current total sale of a dispensed product generated by the pump controller, a final total volume of a dispensed product generated by the pump controller, a final total sale of a dispensed product generated by the pump controller, an alert generated by the pump controller, an error generated by the pump controller, or a data metric generated by the pump controller.

10. The dispenser of claim 1, wherein the system service data includes data characterizing at least one of configuration data of the payment mechanism, a software or a firmware update of the payment mechanism, serial number data of the payment mechanism, status data of the payment mechanism, log data of the payment mechanism, device pairing data associated with the payment mechanism, and remote key injection data associated with the payment mechanism.

11. The dispenser of claim 1, wherein the system service data is generated responsive to one or more operations performed at the dispenser including at least one of pairing a card reader of the payment mechanism with POS application, pairing a printer of the payment mechanism with the POS application, updating a driver of the payment mechanism, updating a firmware of the payment mechanism, and synchronizing clock data of the payment mechanism.

12. The dispenser of claim 1, wherein the system service data is generated responsive to one mor more system service events associated with the one or more operations of the dispenser, the one or more system service events including at least one of an online event, an offline event, a status change event, a battery status change event, a network status change event, a reboot event, a software update completion event, and a log completion event generated by the payment mechanism.

13. The dispenser of claim 1, wherein the dispenser is at least one of a petroleum fuel dispenser, an electric vehicle charger, an LNG dispenser, a CNG dispenser, and a DEF dispenser.

14. A method, comprising:
receiving, by a POS application of a dispenser, first data characterizing an installation package of a payment mechanism of the dispenser, the payment mechanism including a memory and a payment data processor, the installation package including a signature file associating the installation package with a third-party corresponding to the POS application;
verifying the installation package based on the signature file;
generating, by the POS application, an update software request and transmitting the update software request to a first virtualized TCP server communicably coupling the payment data processor of the payment mechanism to the POS application;
generating, by the first virtualized TCP server, a software state request and transmitting the software state request to the payment data processor;
comparing, by the first virtualized TCP server, hashed data associated with application file data stored in the memory of the payment data processor to hashed data associated with files of the installation package;
transmitting, by the first virtualized TCP server, the installation package to the payment data processor for installation; and
initiating, by the payment data processor, a system service communication interface between the POS application and the payment data processor, the system service communication interface configured to exchange system service data therebetween via the first virtualized TCP server responsive to one or more operations performed at the dispenser.

15. The method of claim 14, further comprising generating, by the first virtualized TCP server, a system information request and transmitting the request to the payment data processor; and responsive to receiving a system information response, generating, by the first virtualized TCP server, an application update status event and providing the update status event to the POS application, the update status event indicating an outcome of installing the installation package in the memory of the payment mechanism.

16. The method of claim 14, wherein the system service data includes data characterizing at least one of configuration data of the payment mechanism, a software or a firmware update of the payment mechanism, serial number data of the payment mechanism, status data of the payment mechanism, log data of the payment mechanism, device pairing data associated with the payment mechanism, and remote key injection data associated with the payment mechanism.

17. The method of claim 14, wherein the update software request defines a logical distribution path identifying a file location or directory path associated with a location of the installation package.

18. The method of claim 14, wherein the first data is received via a memory device storing the installation package, the memory device communicably coupled to the POS application.

19. The method of claim 14, wherein the first data is received via a cloud computing device associated with the third-party.

20. The method of claim 14, wherein responsive to receiving the installation package at the payment data processor, the first virtualized TCP server is further configured to reset the payment mechanism and the payment mechanism is configured to reboot to install the installation package.
